(19) United States
(12) Patent Application Publication
(10) Pub. No.: US 2012/0022674 A1
(43) Pub. Date: Jan. 26, 2012

(54) APPLICATION SPECIFIC VIRTUAL REAL-TIME OPERATING SYSTEM COMPILER

(76) Inventor: Yun Peng Choo, South Australia (AU)

(21) Appl. No.: 12/746,944

(22) PCT Filed: Dec. 15, 2008
(86) PCT No.: PCT/AU08/01836

§ 371 Date: Dec. 1, 2010

(30) Foreign Application Priority Data
Dec. 13, 2007 (AU) 2007906752

(51) Int. Cl. G05B 19/42

(52) U.S. Cl. 700/86

(57) ABSTRACT

A mechanism to automate the design and programming of programmable control systems. Using graphical software representations, there is provided a set of sub-circuits that can be selected and attached to a graphical representation of a programmable controller. Technical information for the construction and testing of the programmable controller system are generated automatically by the mechanism. Another mechanism then automates the construction of structure and timing of the control software to fit all task requirements of the control system. The stand alone control software then operates in real time on the programmable controller system.

### TECHNICAL FIELD

This invention relates to devices for automating the generation of technical data and software for electronic programmable controller systems.

### INCORPORATION BY REFERENCE

This invention may be applied in conjunction with the invention described in PCT application number PCT/AU02/00871. The entire content of this specification is hereby incorporated by reference.

### BACKGROUND

Electronic Circuits need to be connected to programmable controllers for three main reasons: 1) To supply the correct level of power 2) To process input signals so they are within controller specific limits and 3) To process output signals from the controller to useful control actions. These inputs are typically read by the programmed software, are processed as required and then signals are placed on the outputs to perform the desired control task.

Currently a person with sufficient technical knowledge of electronic circuits will take specifications and draw the needed circuits for a new programmable control system. This person will also produce a table of connections to the programmable controller, specifying the type of signals connected and clearly stating their purpose.

Typically another person with sufficient technical knowledge of programmable controllers will take the circuit drawings and table of connections to produce the software needed to run the programmable controller for the specified control application.

Some of the difficulties with this programmable controller project include: 1) transferring sufficient and correct information from the specification to the person with electronic circuit knowledge 2) the possible limited knowledge of the circuit designer 3) testing the electronic circuit for correct operation 4) transferring sufficient and correct information from the circuit design to the person who produces the software 5) producing software in such a way that it is clear and readable to any other person who may need to change it 6) working within the time and budget allocated to the project.

The existing devices for managing the above difficulties are typically systems of required paperwork and checking by a project management person. Although the project may run smoothly when these systems are properly implemented, the systems themselves usually add time and extra work to the overall project.

Some existing devices do allow for sub-tasks and objects to be grouped and manipulated by computer. For example a Computer Aided Design (CAD) circuit schematic program can combine circuits and generate parts lists. Such devices have the limitation of being constrained to the electronics or components of the circuit and do not help with software or broader project management.

To most people, embedded systems are not recognizable as computers. Instead, they are hidden inside everyday objects that surround us and help us in our lives. Embedded systems typically do not interface with the outside world through familiar personal computer interface devices such as a mouse, keyboard and graphic user interface. Instead, they interface with the outside world through unusual interfaces such as sensors, actuators and specialized communication links.

Real-time and embedded systems operate in constrained environments in which computer memory and processing power are limited. They often need to provide their services within strict time deadlines to their users and to the surrounding world. It is these memory, speed and timing constraints that dictate the use of real-time operating systems in embedded software.

Currently the “kernel” of a real-time operating system (“RTOS”) provides an “abstraction layer” that hides from application software the hardware details of the processor (or set of processors) upon which the application software will run. This “kernel” software resides and runs on the embedded controller to provide the services to application software running on a processor. These services include Task Management, Intertask Communication and Synchronization, Timers, Device I/O Supervisor and Memory Allocation.

Currently a person with sufficient technical knowledge of a RTOS will write application tasks that make use of the services available on the particular RTOS that has been chosen for the embedded system.

Some of the difficulties in choosing or developing a suitable RTOS include:
1) Memory constraints. A smaller RTOS is desirable. RTOS can be small and less flexible or larger and more flexible. Memory is usually limited in an embedded system forcing a compromise on ultimate flexibility to keep the RTOS size small.
2) Flexibility of the RTOS. A more flexible RTOS is desirable. This conflicts with memory constraints.
3) Speed of the RTOS. A faster RTOS is desirable. A more flexible RTOS will tend to be slower.
4) Predictability and stability of the RTOS. A predictable stable system is essential. This places constraints on the flexibility and speed of the RTOS.

Further difficulties arise from the limits of a users technical knowledge of the RTOS. It may take quite a long time to become familiar with a particular RTOS and hence this may be used in preference to a RTOS that better fits the embedded system requirements.

Each embedded system has its own special requirements and currently a RTOS may be chosen or constructed that best fits the needs. The above difficulties and constraints lead to either compromises or extremely long development times to tailor make a custom operating system.

It is an object of the present invention to reduce or eliminate these difficulties and limitations while reducing the time and work needed to construct the application task software for embedded systems.

### SUMMARY

According to the first aspect of the present invention there is a computer software mechanism to automate the development and management of a programmable controller system. The software mechanism typically consists of graphical object elements that can be manipulated by a person wishing to produce a programmable controller system.

Using graphical software representations, there is provided a set of sub-circuits that can be selected and attached to a graphical representation of a programmable controller. Each sub-circuit contains data for the user so the user can make an informed selection and add this element to the new system. Each sub-circuit also contains signal data as to what type of signal is coming into or out of the sub-circuit.

Typically all the pins of a programmable controller will not accept all types of input and output signals. Hence only the pins that can connect to the signal type in the selected sub-circuit will be available for connection to that sub-circuit.

After the user connects all the sub-circuits that are needed, then technical information for the construction and testing of the programmable controller system are generated automatically by the software mechanism.

Specifically, since each sub-circuit contains a sub-circuit schematic, then the full circuit schematic can be generated as well as a list of the electronic components needed in the system. Also, since the signal type and function of the sub-circuit are also defined, then a complete test procedure for testing the electronics can be generated by listing the signals to be injected into each programmable controller pin and checking that the specified circuit function does operate. Similarly, expected signals on pins can be tested when other sections of the circuit are activated according to their required function.

The signal information in the sub-circuits as well as the connection selections by the user are used to automatically generate many elements of the program software for the programmable controller. These are: 1) Automatic generation of pin assignment software to configure the programmable controller to input or output the required signals 2) Automatic generation of software for setting required controller chip peripheral hardware to process the signals connected to the pins 3) Automatic assignment of variables and variable names for the signals and pins to be accessed 4) Information about operating system requirements to be implemented in the software.

According to the second aspect of the present invention there is a second computer software mechanism that is related to the first mechanism to automate the development and management of application task software for embedded systems. The user of the software provides the information about the tasks that are to be performed and their real-time constraints and parameters. The user then fills in the details of each task by specifying the software that will execute the task.

The second software mechanism will then compile the tasks into an order that fills the needs of the real-time constraints and parameters. It only adds extra instructions if needed to create specific and stable timing loops. Hence a virtual Real Time Operating System (RTOS) is constructed by this software mechanism to provide for the specific needs of the embedded system.

Hence the second software mechanism tailors the fastest possible RTOS that meets the exact needs of the embedded system tasks without including an “abstraction layer” of executable software. The user and this software mechanism compiler have done the abstraction. Hence the RTOS on the embedded system is “virtual” and takes no memory or speed resources from the embedded system to implement.

Specifically, since each task has a time constraint, they can be grouped into a “fast loop task” and a “slow loop task”. The refresh time of both types of tasks is met by making sure that the loop time is less than the maximum required time as set by the user. This way task priorities and passing of data between tasks is handled in a consistent and stable way. This invention is not limited to two “loop task” sets and it is apparent that it can be extended to more “loop task” levels.

It is noted that the present invention is limited to fixed task embedded systems. If a new task must be added to the system then it must be added to the Software Mechanism and the virtual RTOS re-compiled before updating the Embedded System program memory. This is not a limitation on most Embedded Systems since currently a new task is usually constructed on a separate computer before compiling and downloading to the Embedded System program memory.

As an extension to the present invention, it is noted that an embedded computer may be used to run the Software Mechanism to re-compile the embedded controller that is executing the tasks. This interruption could be handled by having at least two available task executer controllers so one can continue to run real-time tasks while the second is being updated. Then the second controller could quickly take over the running of the tasks under an updated real-time operating system. Since the entire embedded system can be taken into account in the present invention, it is apparent that the Software Mechanism can easily be applied to share tasks on multiple embedded controllers.

It is noted that the present invention is similar in many ways to a computer “language” in that it can become a consistent interface in spite of the specific machine code requirements of the embedded system. The present invention also “compiles” the required machine code rather than running an embedded “interpreter” type of RTOS. However, the Software Mechanism greatly differs from languages in that is based on RTOS requirements of the complete embedded system and automatically generates a result that fits the requirements of every task in the system. Current computer “languages” do not cater for these requirements since they are based on sequential task execution. The users of current computer “languages” must manually create the RTOS structure or select one that “interprets” the language tasks on the embedded controller.

### BRIEF DESCRIPTION OF THE DRAWINGS

The invention will now be described in more detail with reference to the following figures and tables in which:

FIG. 1 shows a block diagram of one possible connection diagram, as it would appear to the user of the present invention;

### DETAILED DESCRIPTION

The selectable sub-circuits according to one aspect of the invention are shown in Table 1. Each sub circuit has descriptive parameters attached to it. Some parameters may be descriptive and aid the user in understanding and using this device.

TABLE 1
Selectable Sub-Circuits

Sub-Circuit 1:
Name: Power
Description: Power Supply Regulator
Input/Output: Input not accessible
Type: Support
Circuit Diagram: Power Regulator1
Components: 7805 Regulator, 2x 100n Capacitors
Sub-Circuit 2:
Name: Switch1
Description: Push Switch
Input/Output: Input
Type: Digital
Circuit Diagram: Switch Diagram1
Components: Switch, 10k resistor
Sub-Circuit 3:
Name: LED1
Description: LED indicator
Input/Output: Output
Type: Digital
Circuit Diagram: LED Diagram1
Components: LED, 390R resistor
Sub-Circuit 4:
Name: Motor1
Description: Differential Drive DC Motor
Input/Output: Output
Type: Digital
Circuit Diagram: Motor Diagram1
Components: DC Motor, L293 Driver
Sub-Circuit 5:
Name: RS232 Interface
Description: Communications
Input/Output: 1 Input, 1 Output
Type: Digital
Circuit Diagram: RS232 Driver1
Components: MAX232 Chip, 5 x 100n Capacitors
Sub-Circuit 6:
User definable

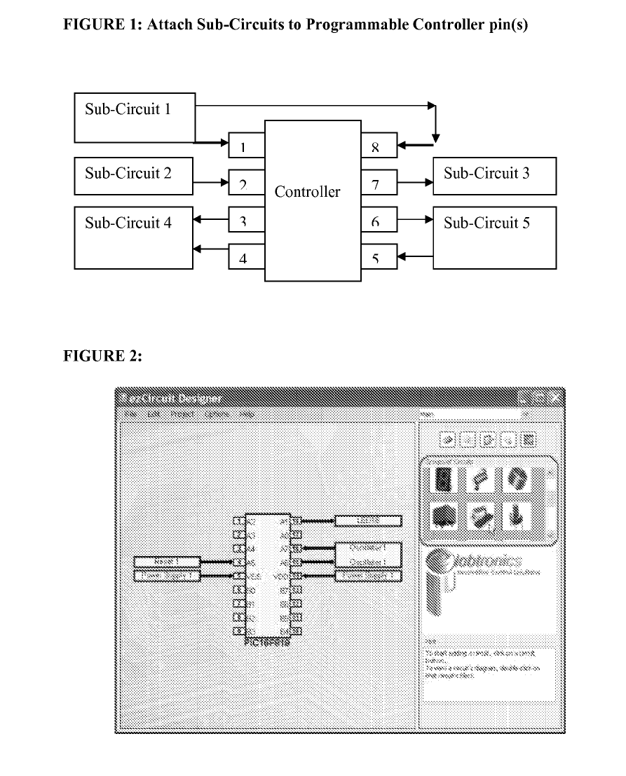

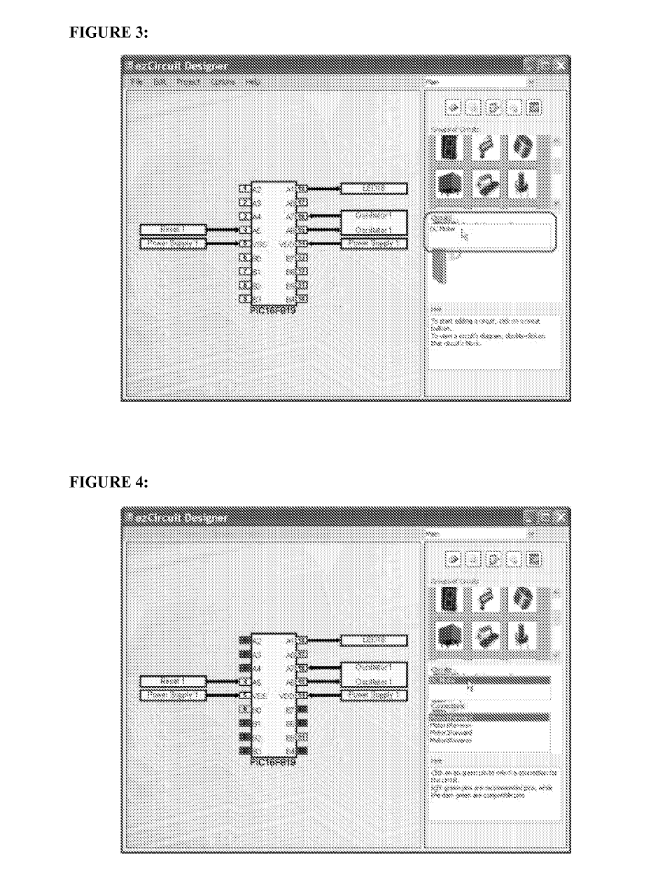

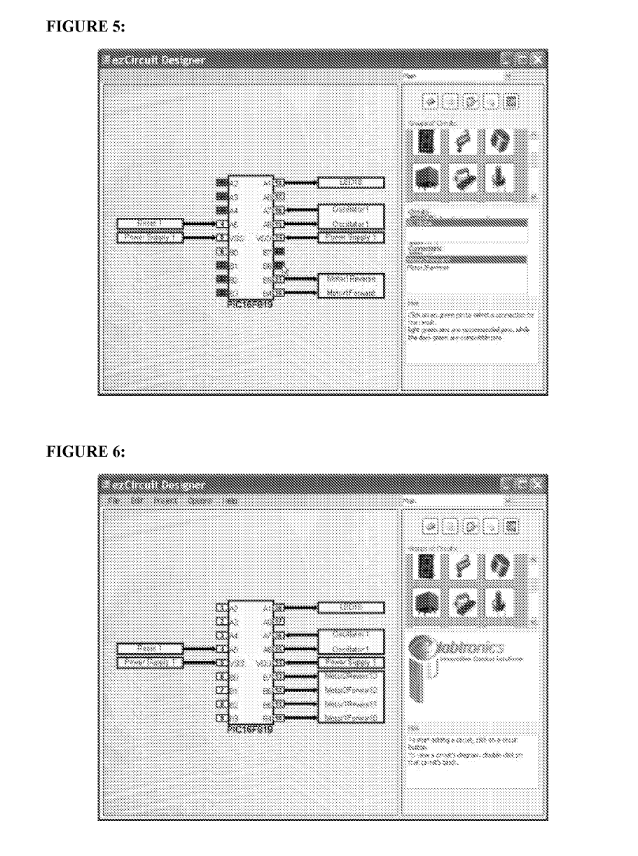

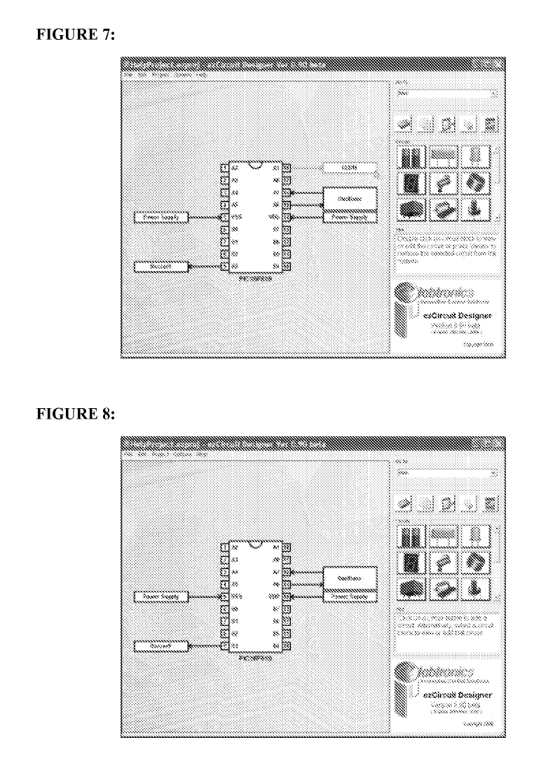

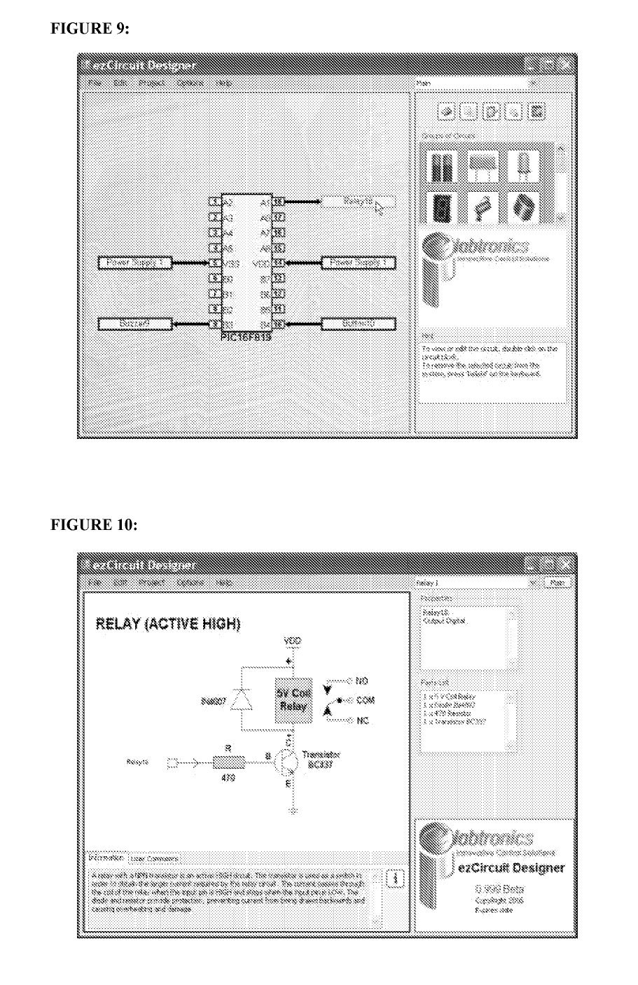

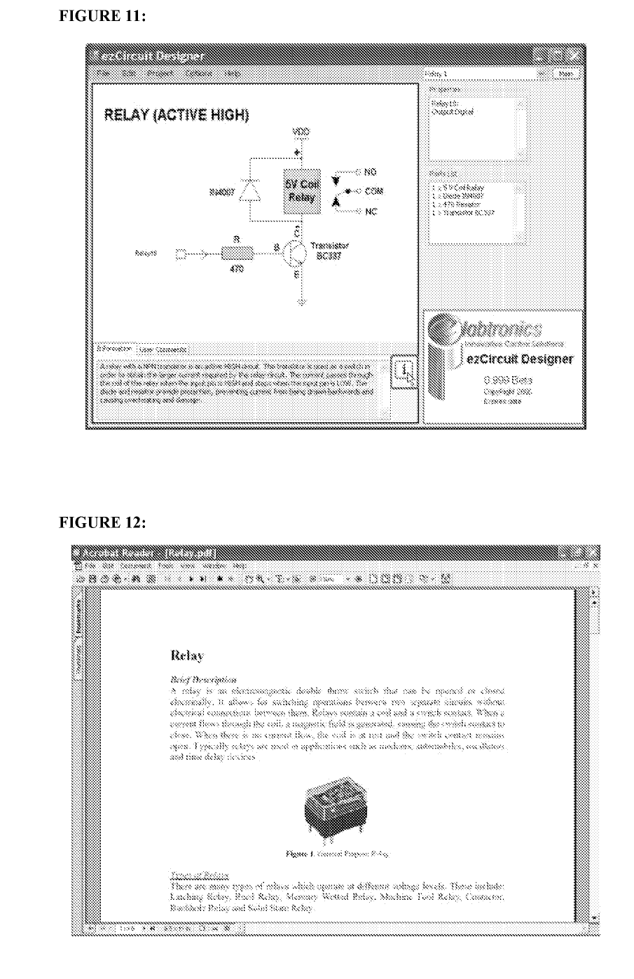

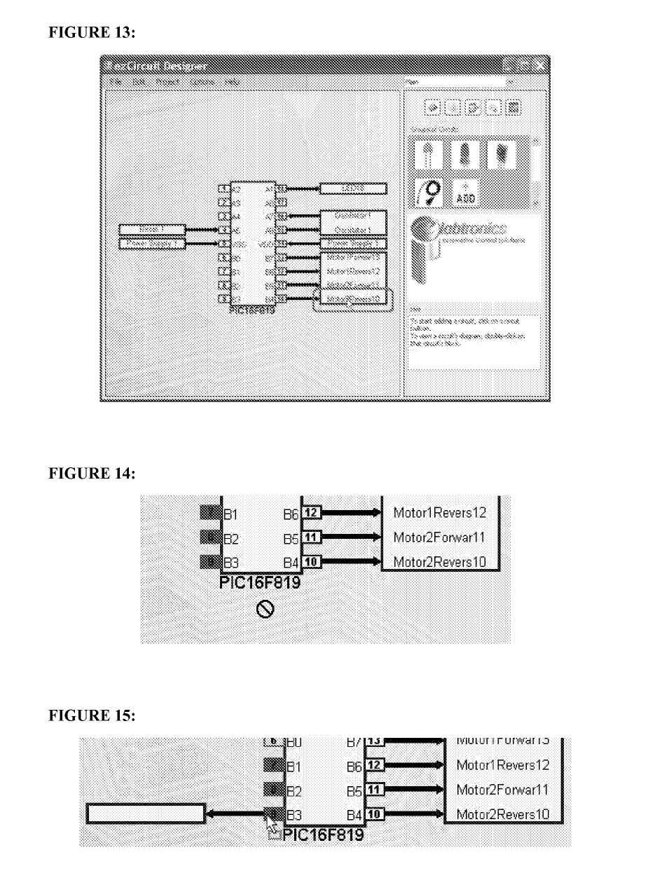

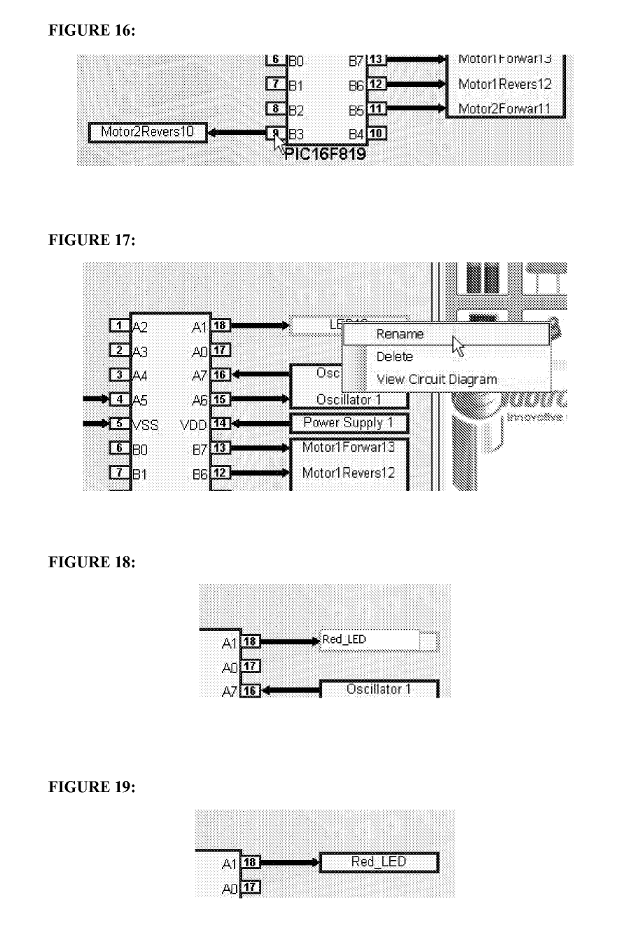

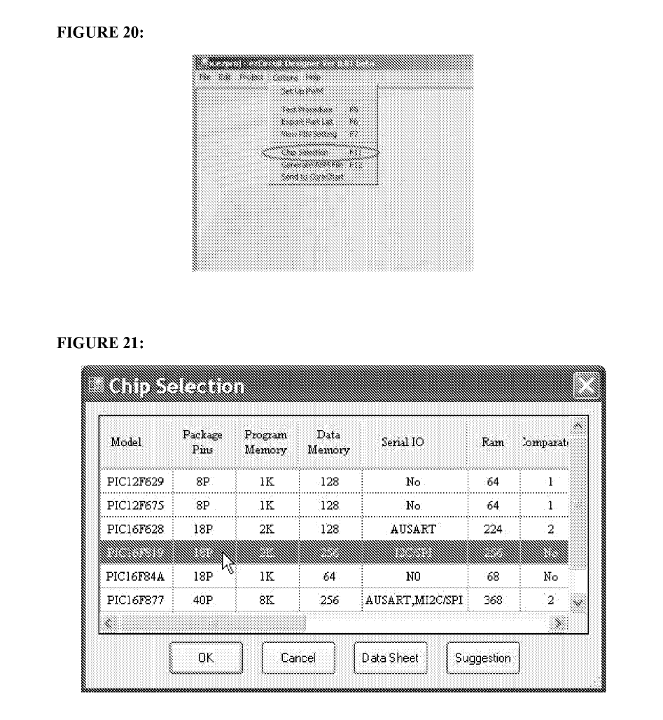

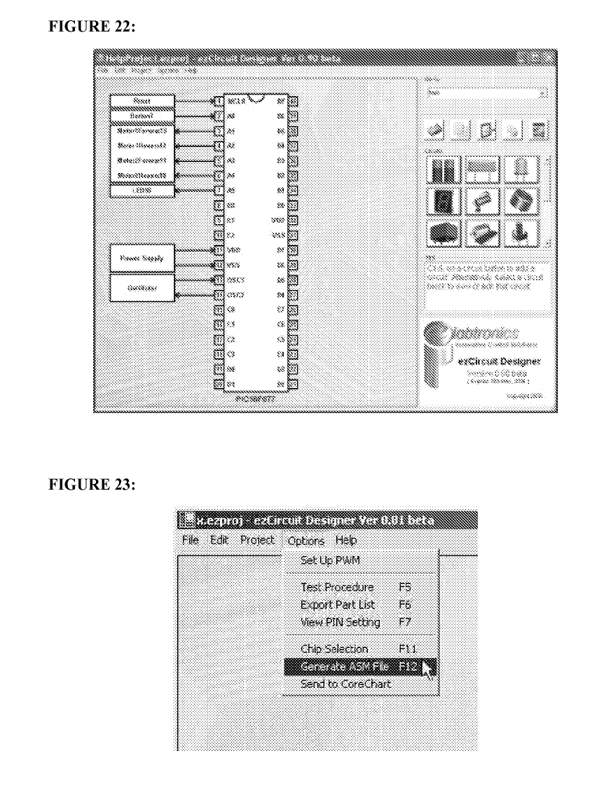

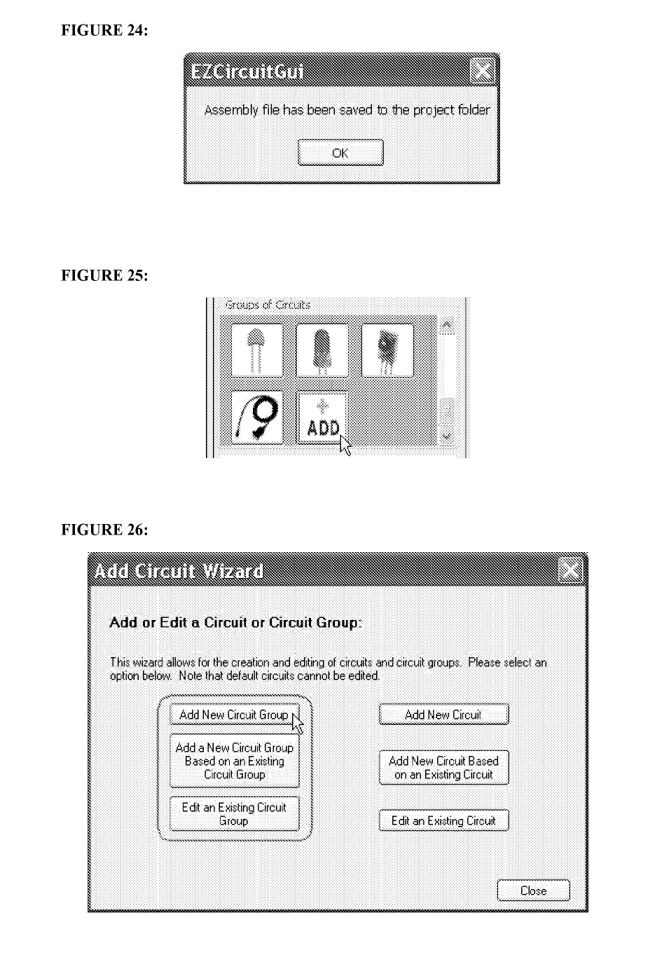

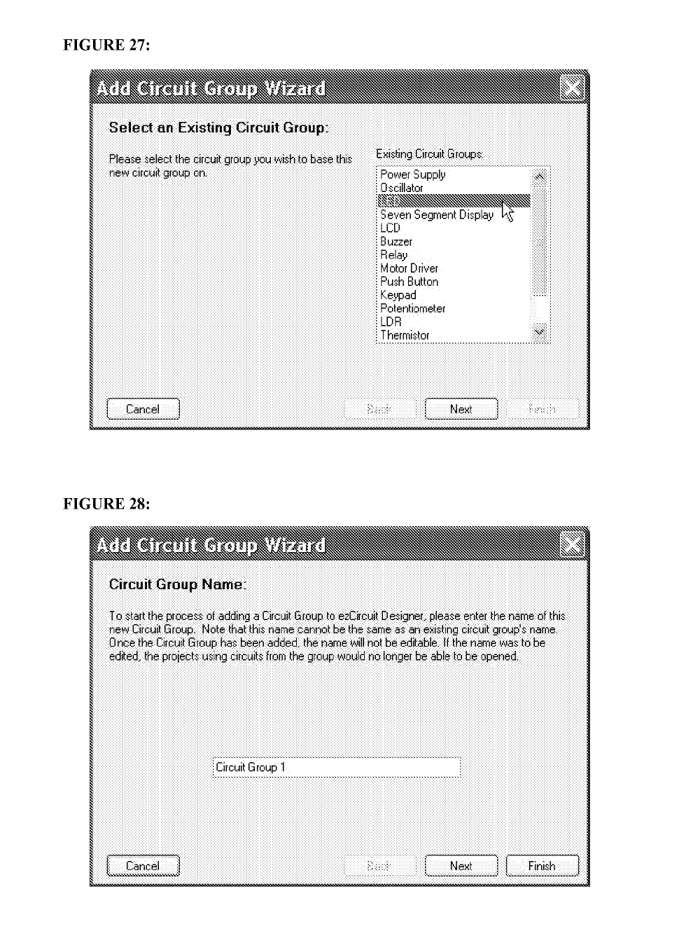

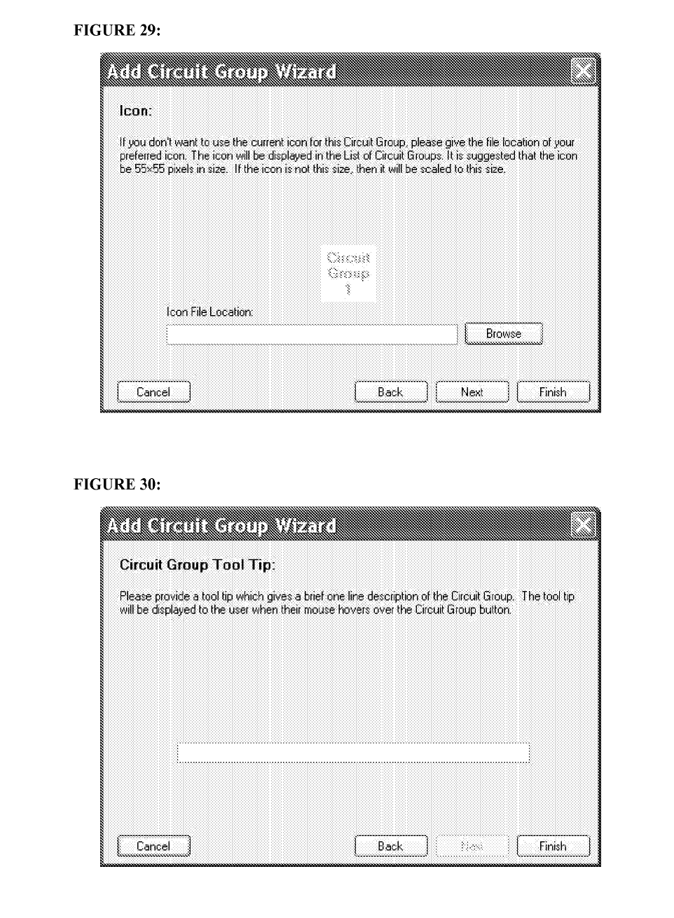

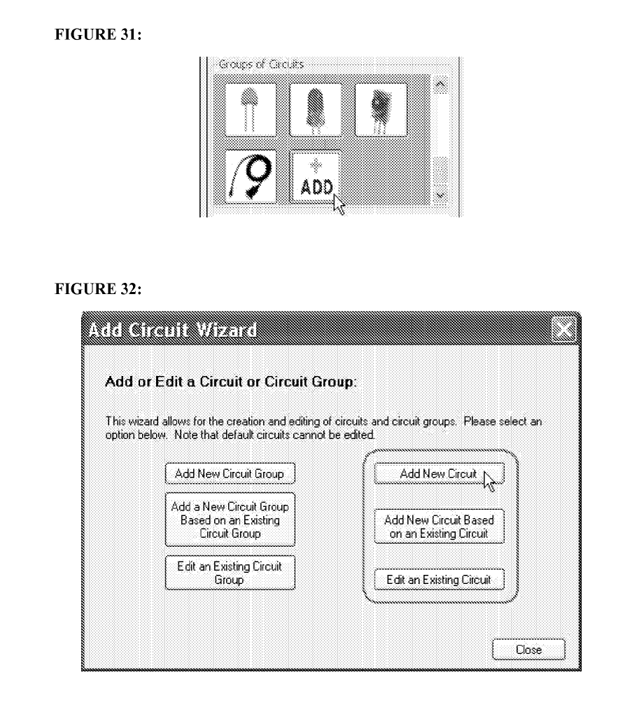

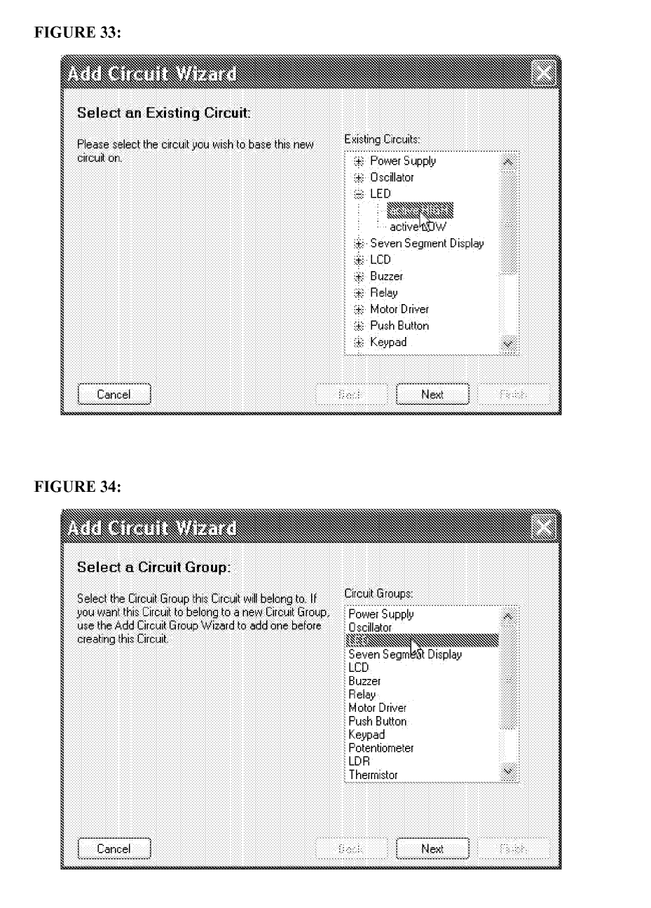

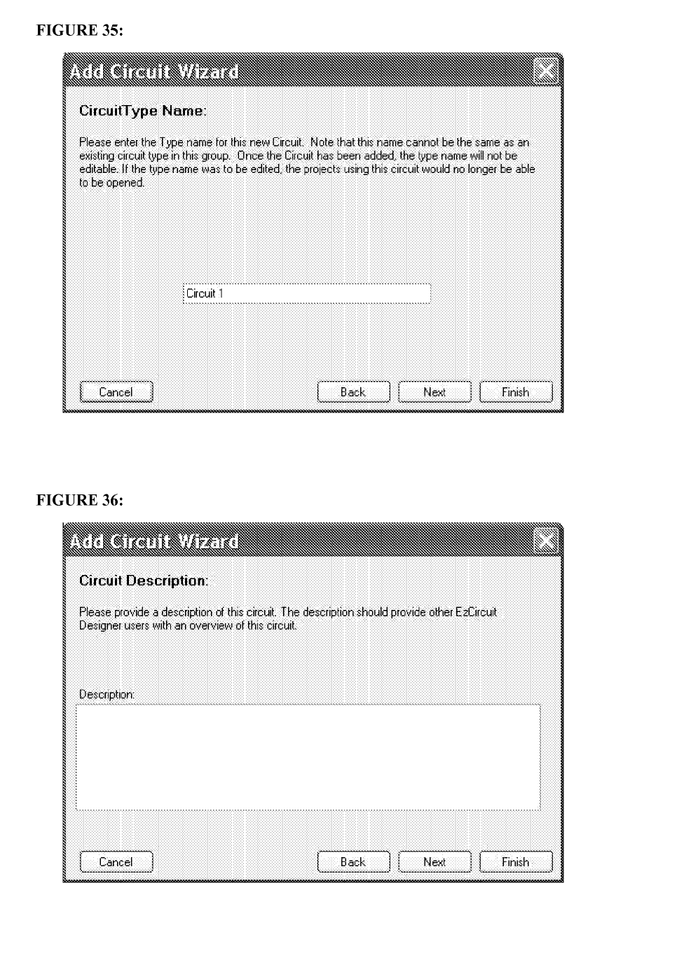

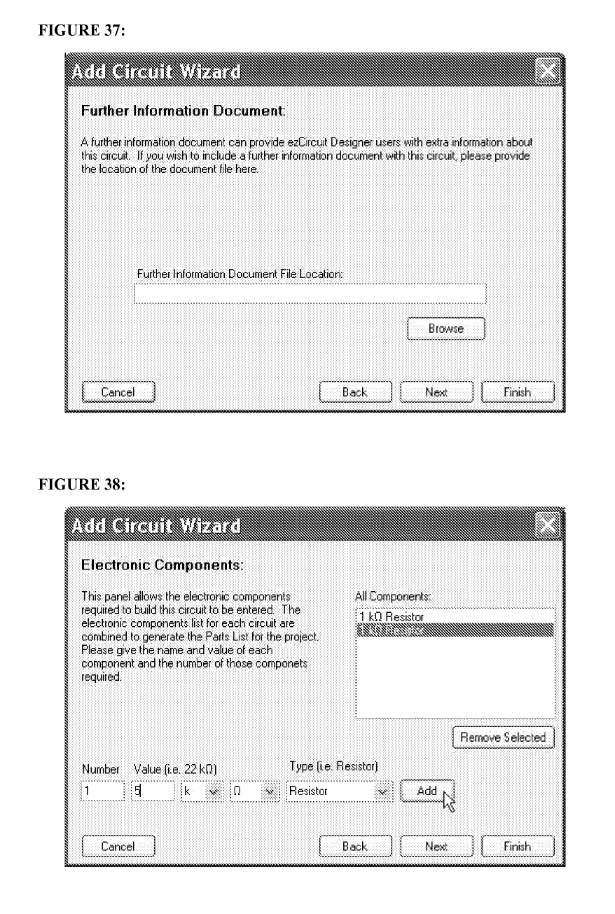

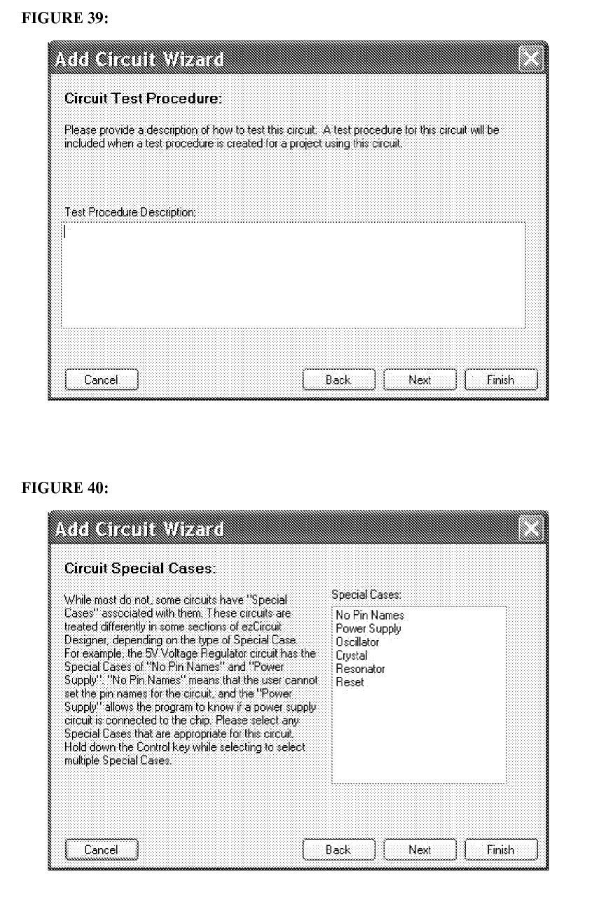

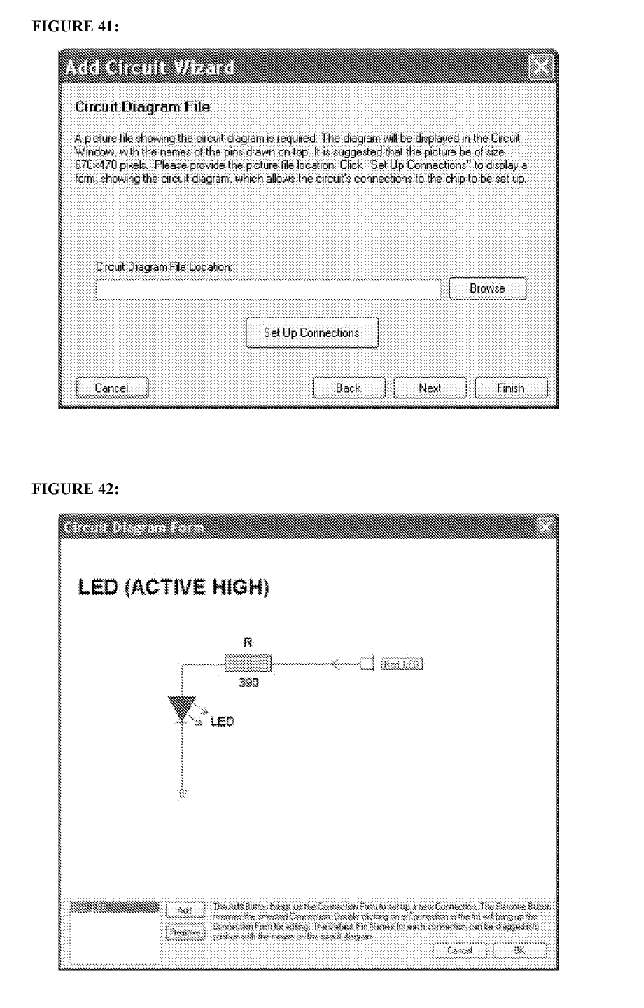

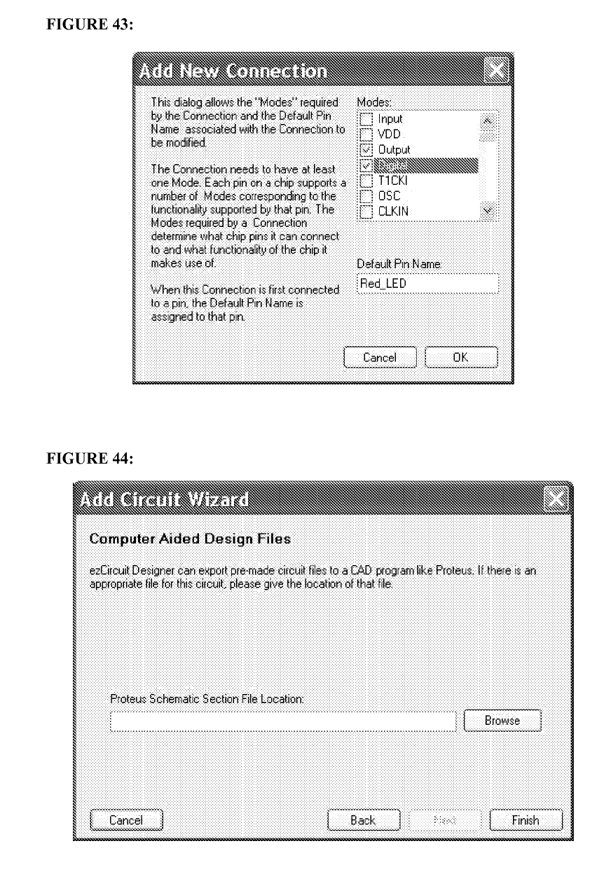

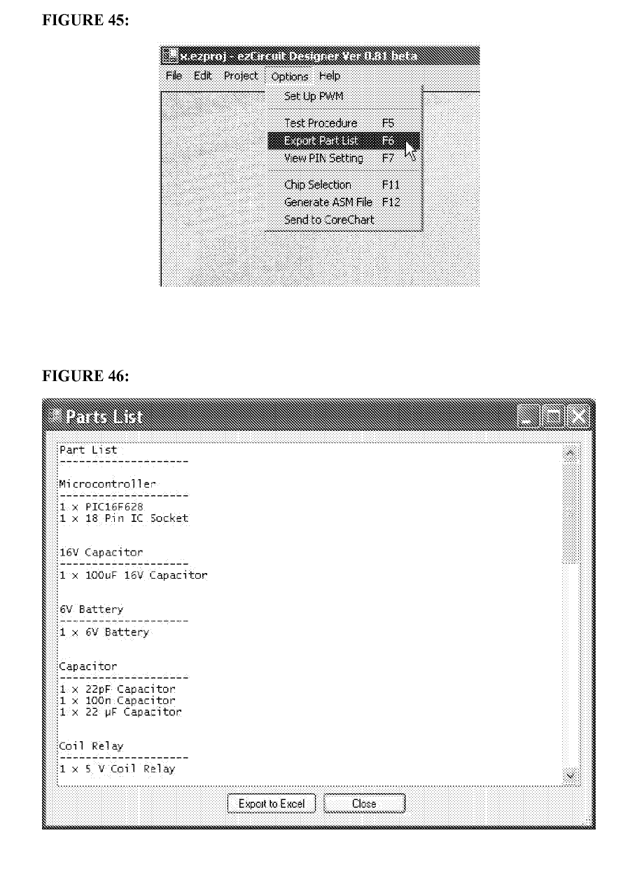

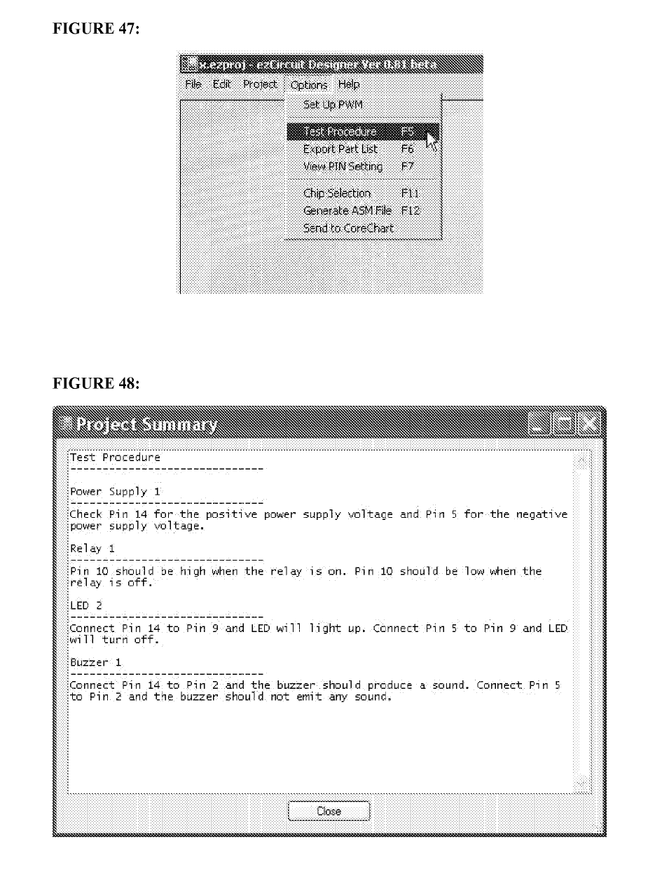

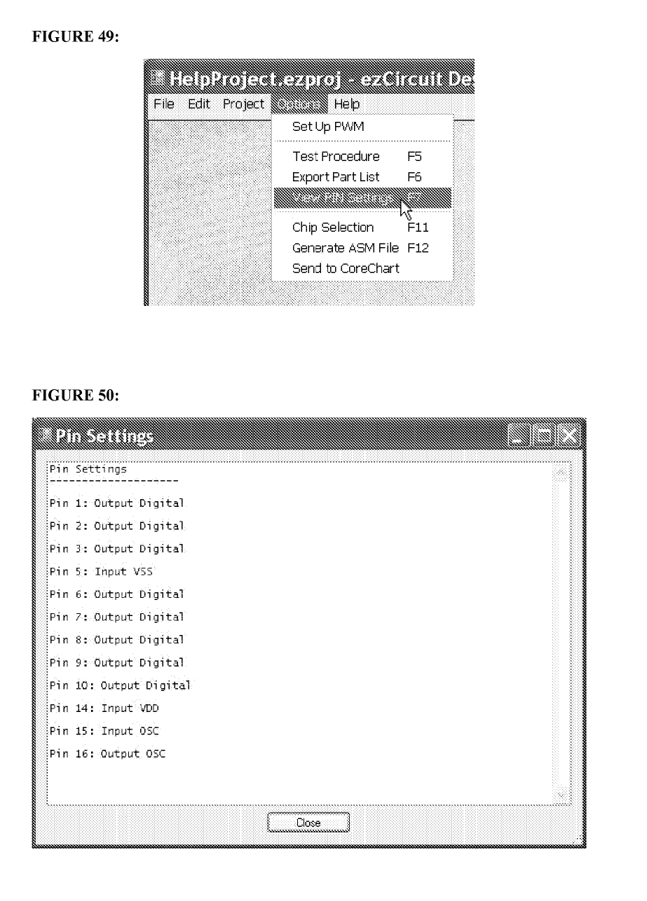

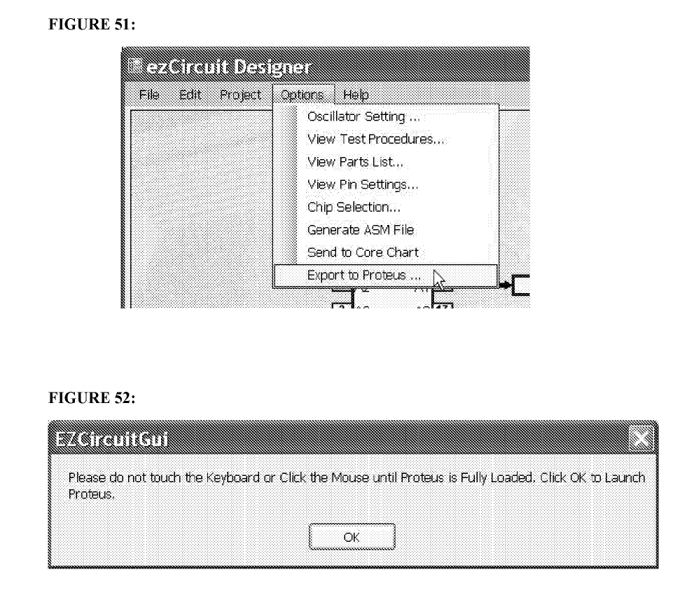

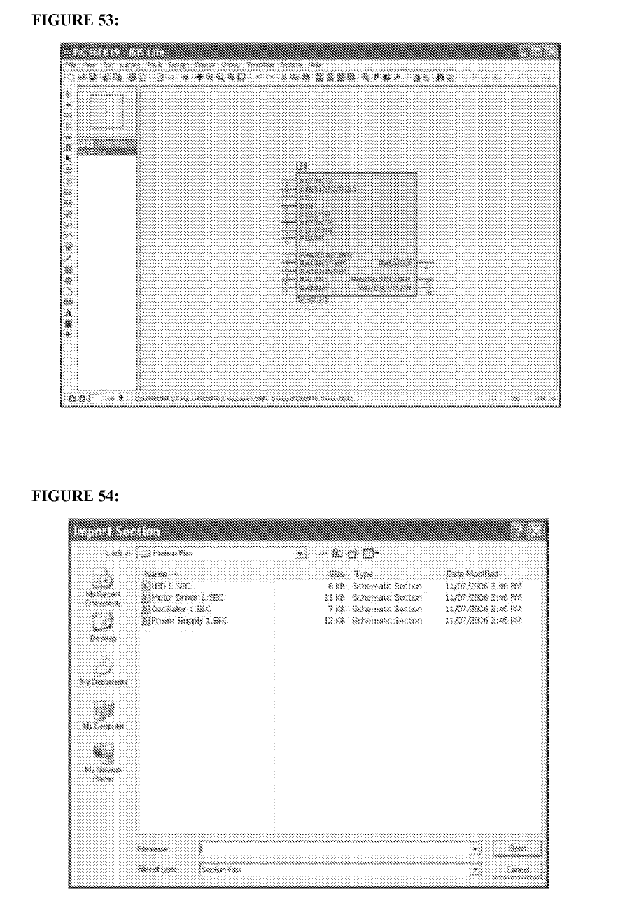

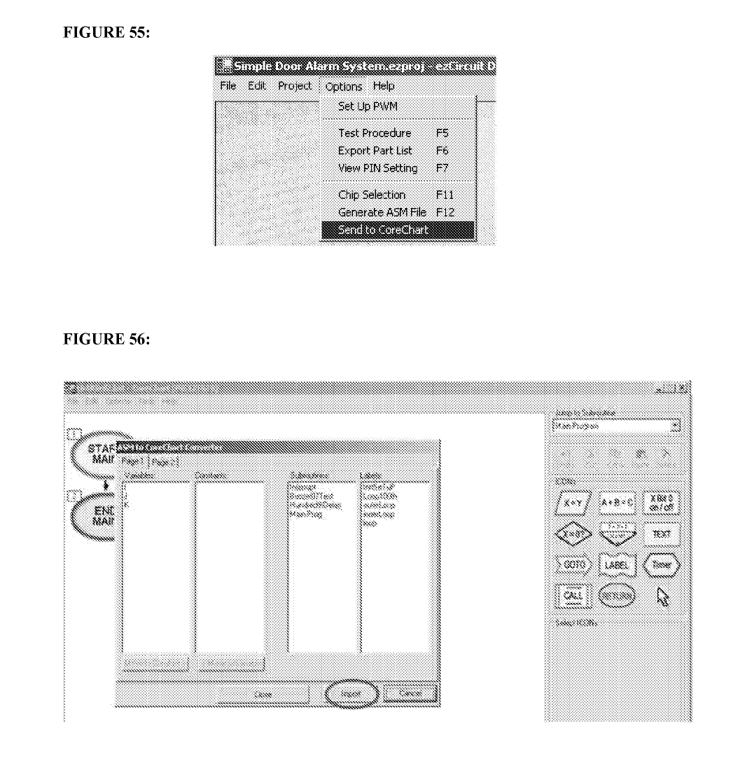

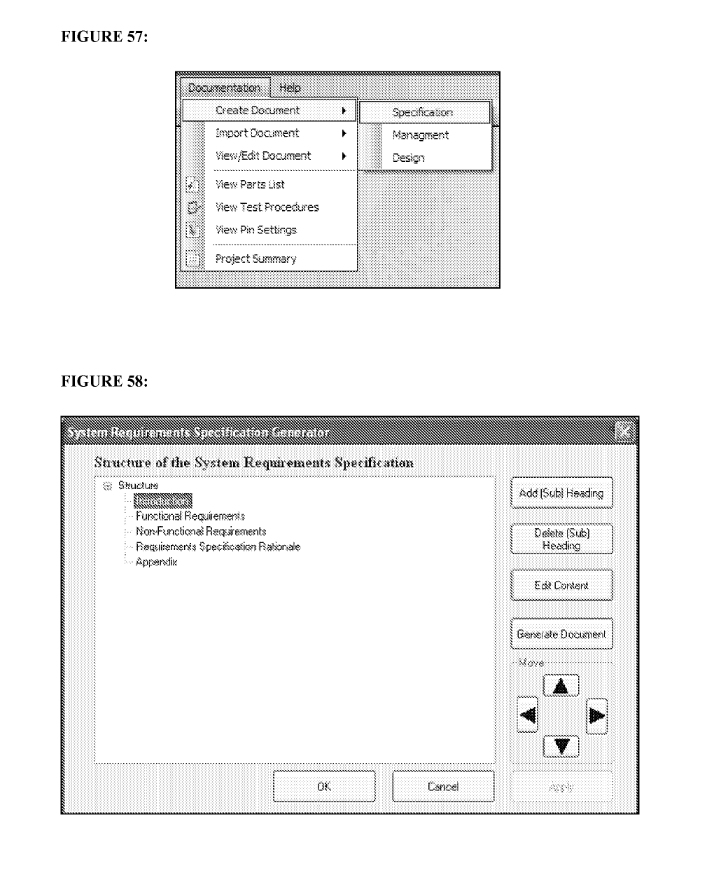

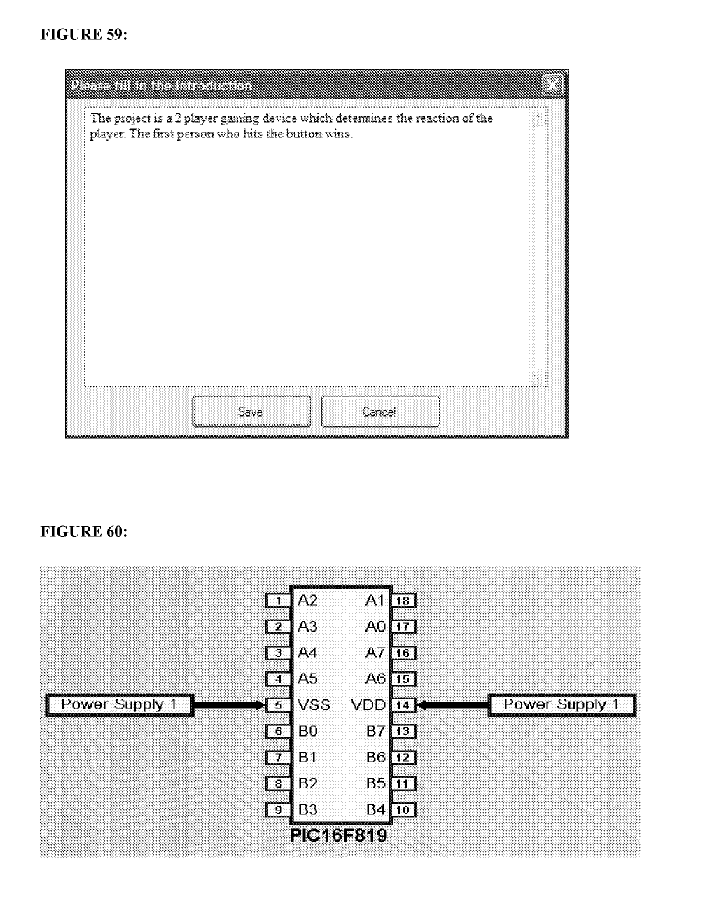

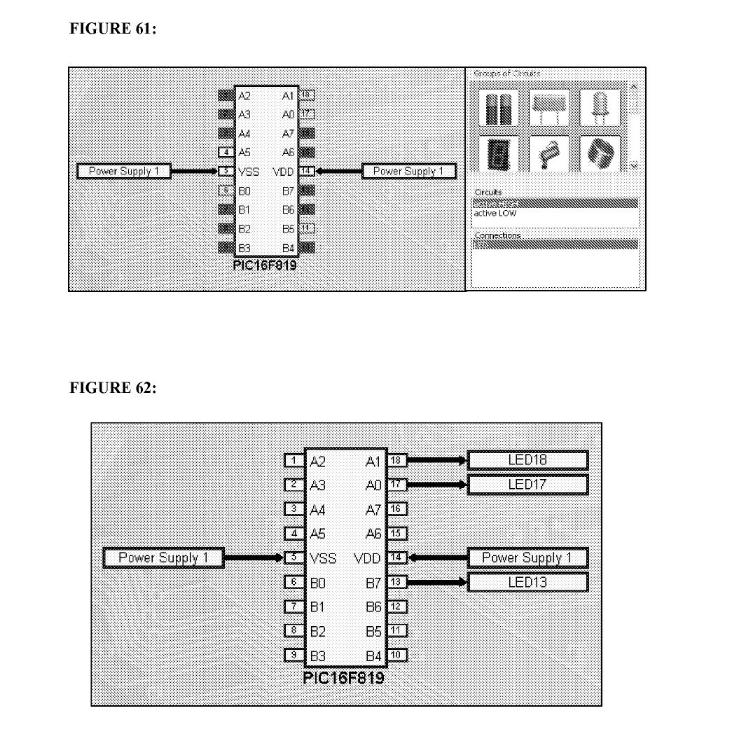

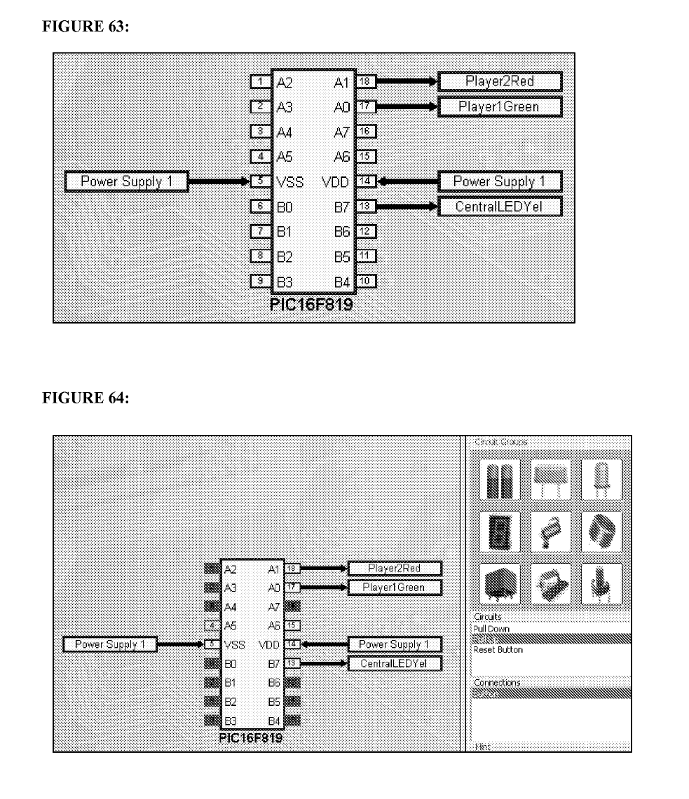

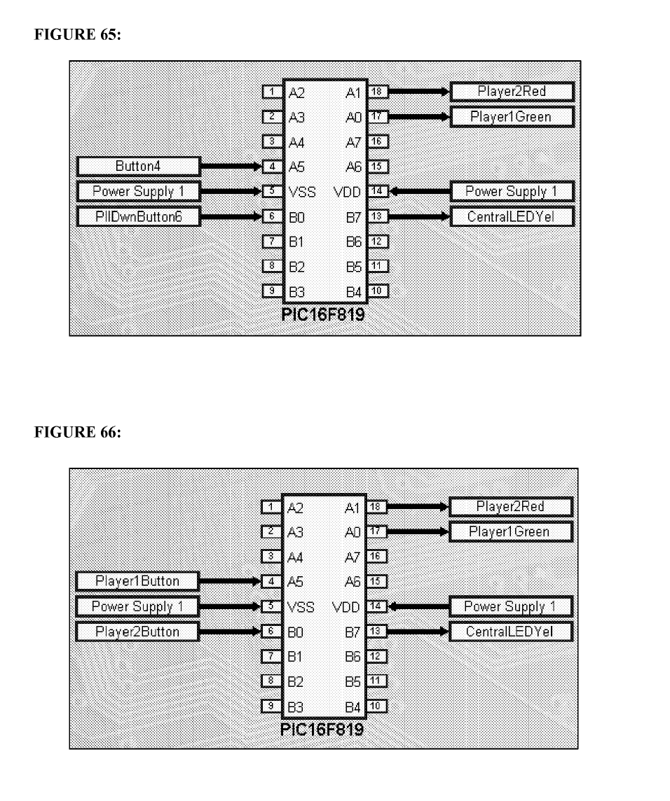

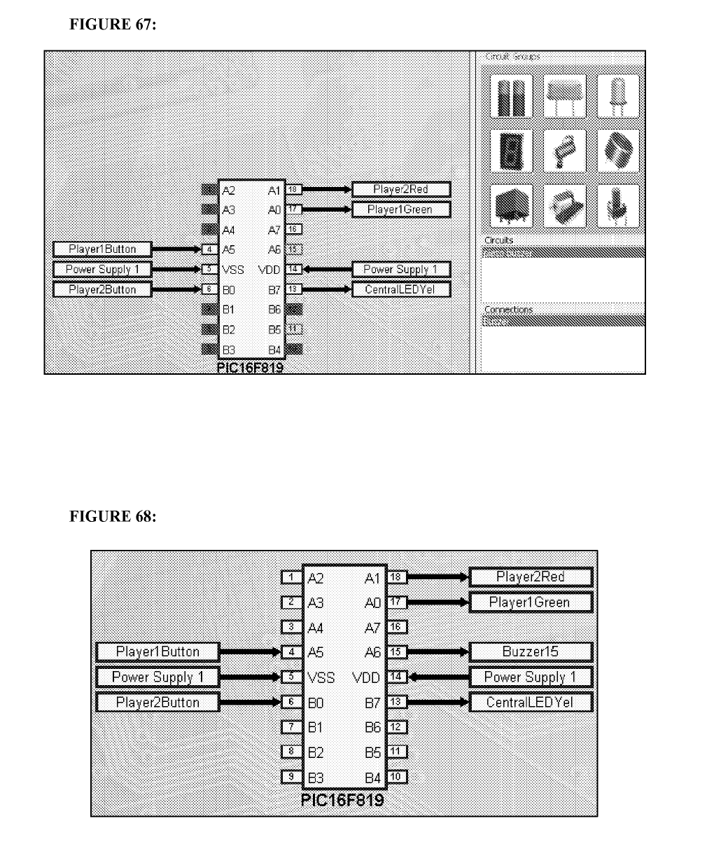

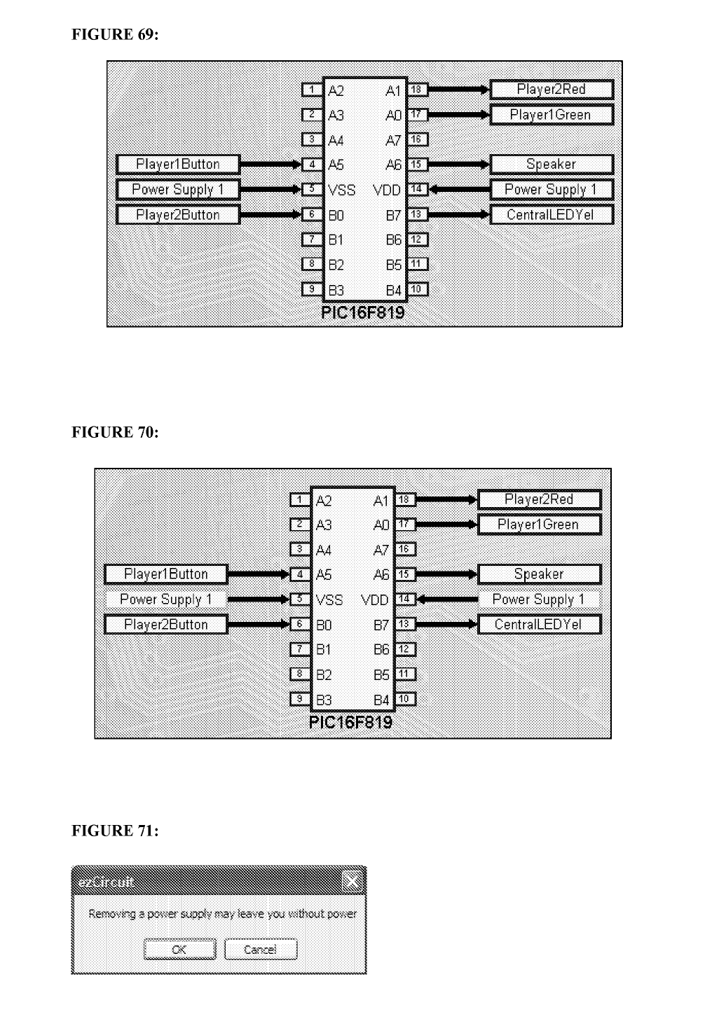

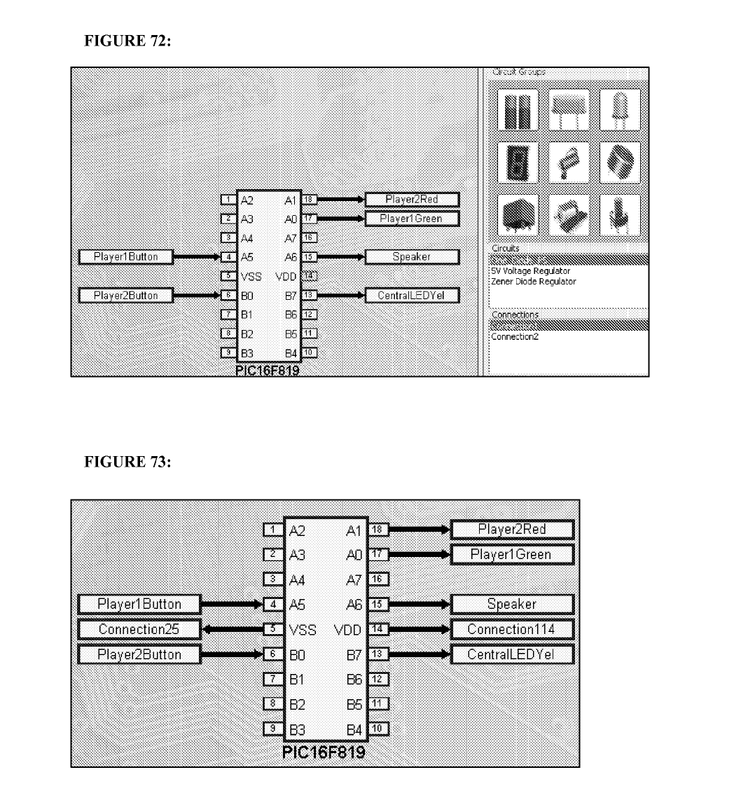

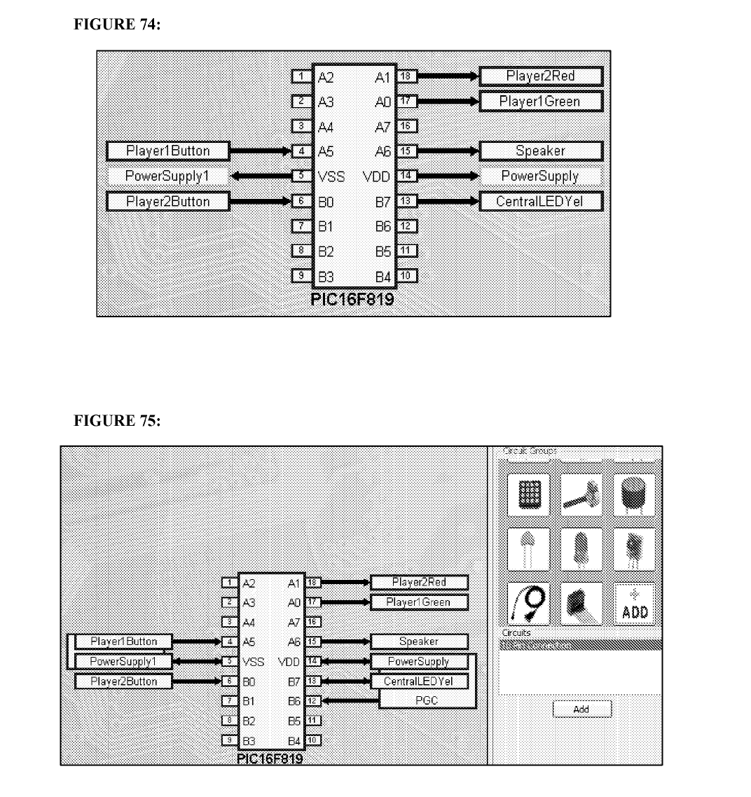

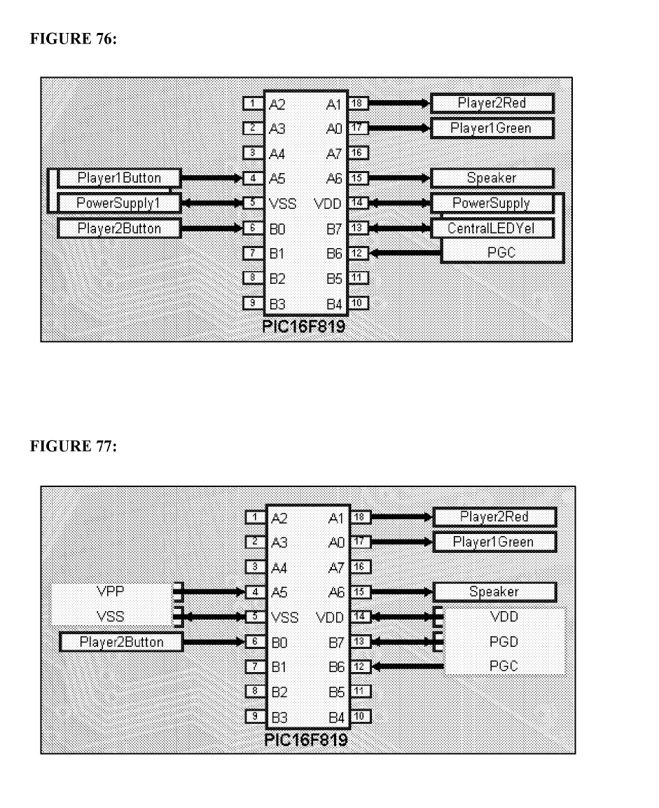

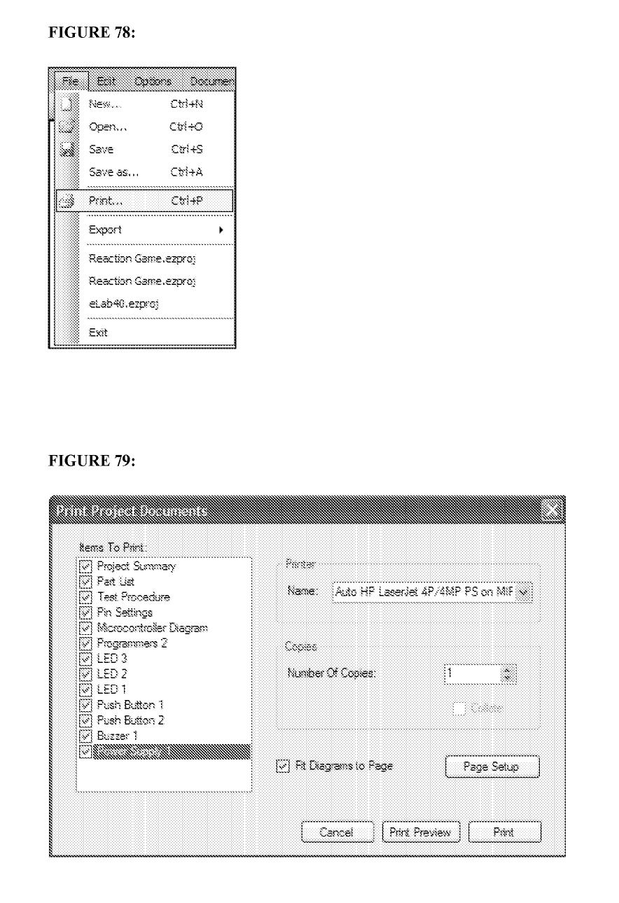

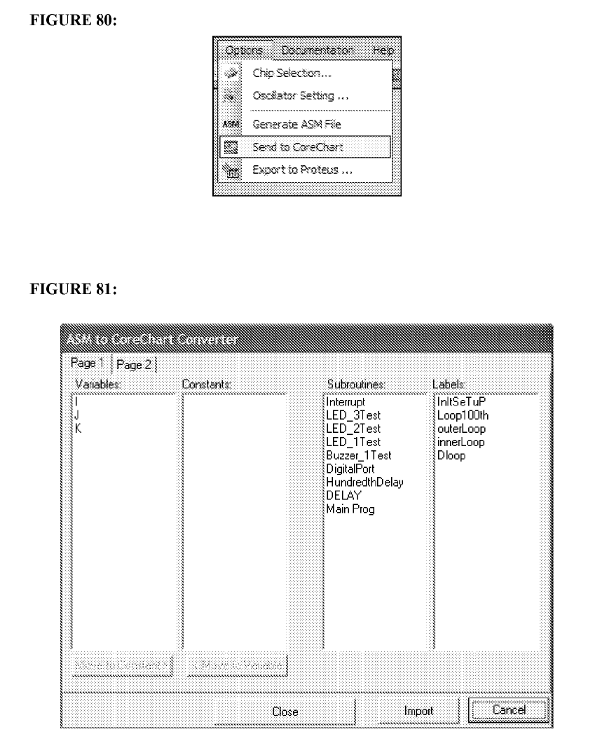

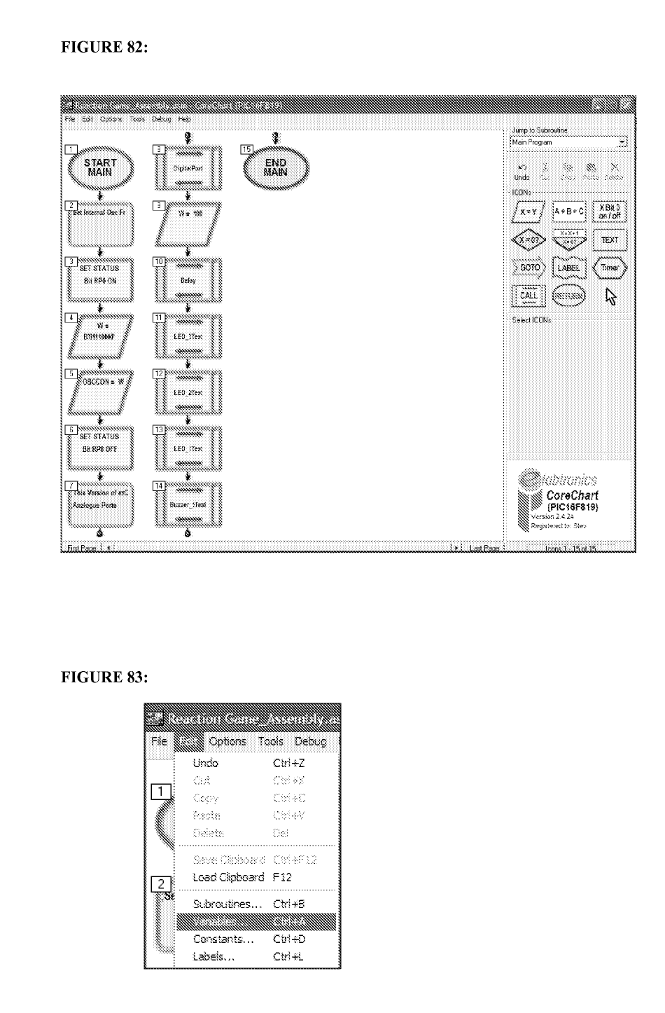

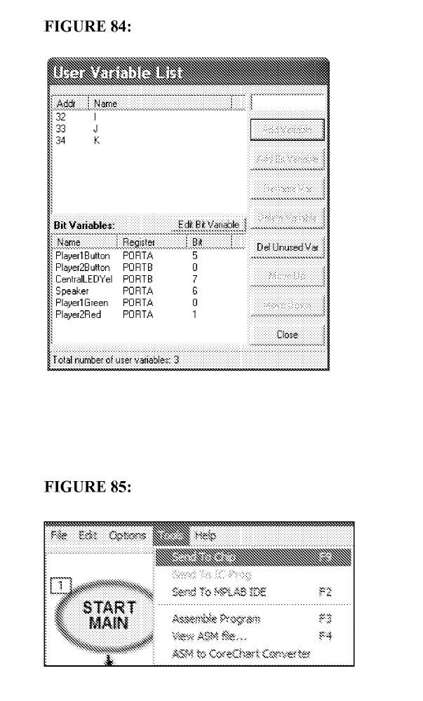

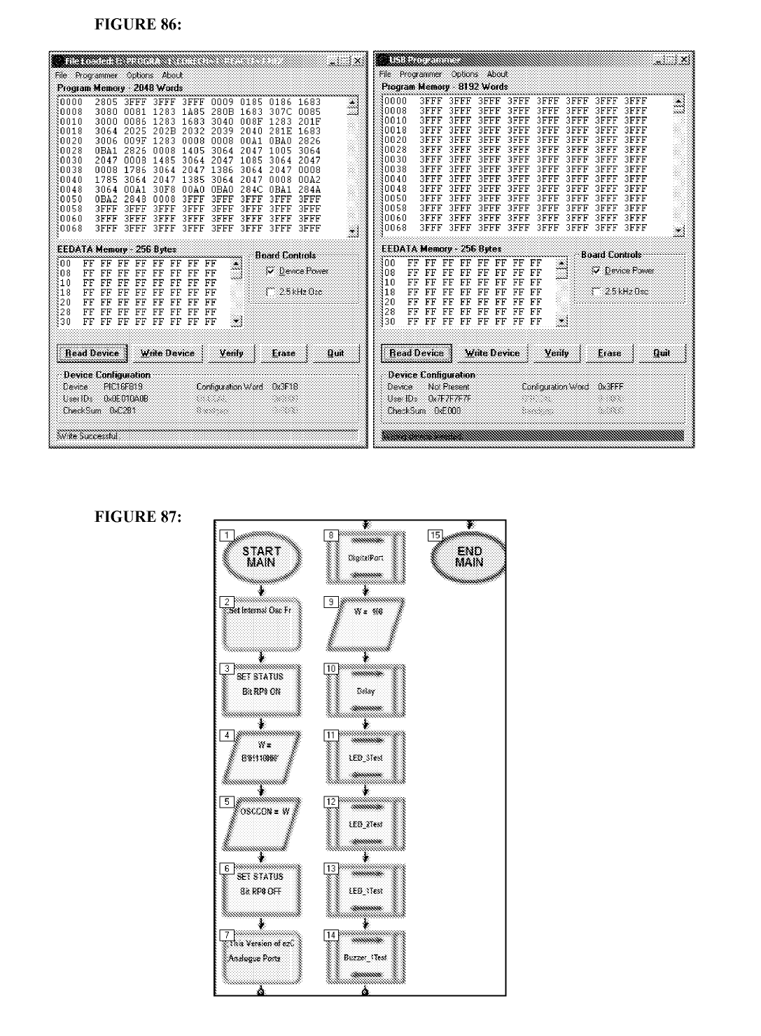

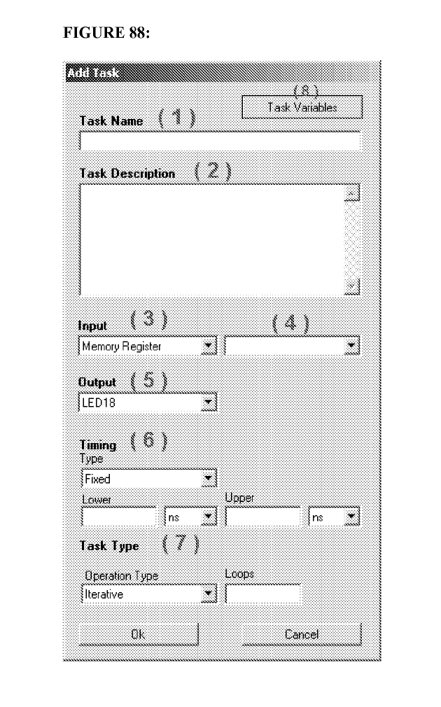

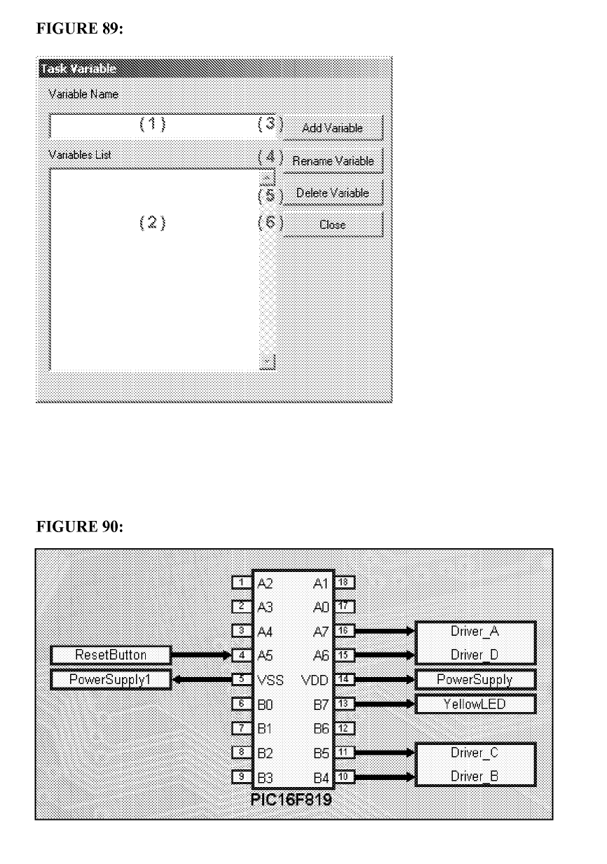

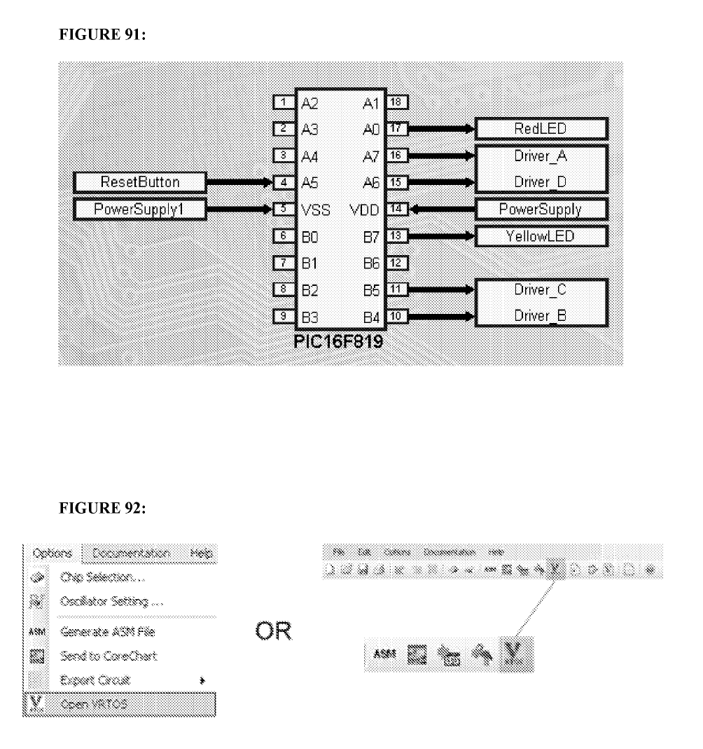

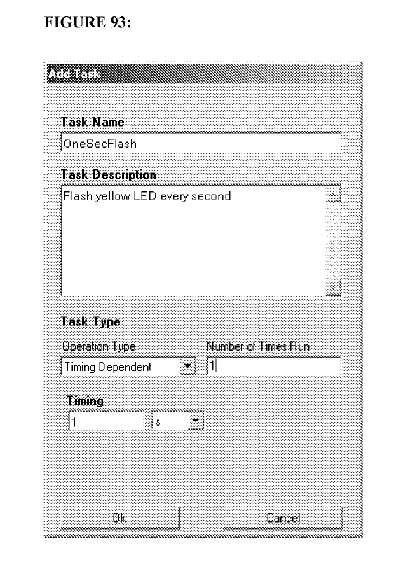

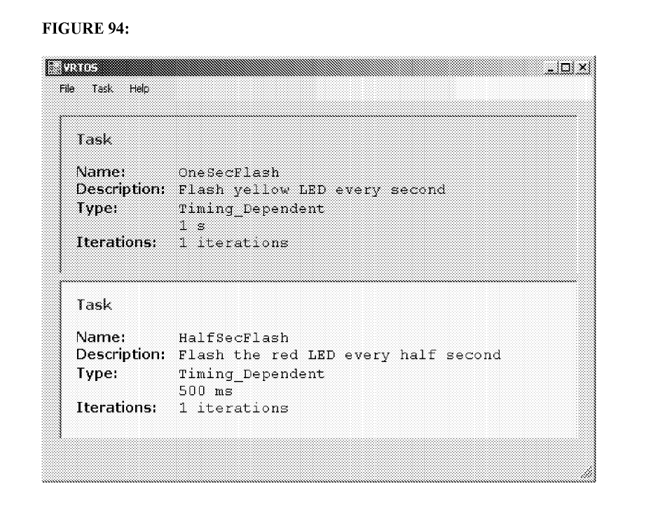

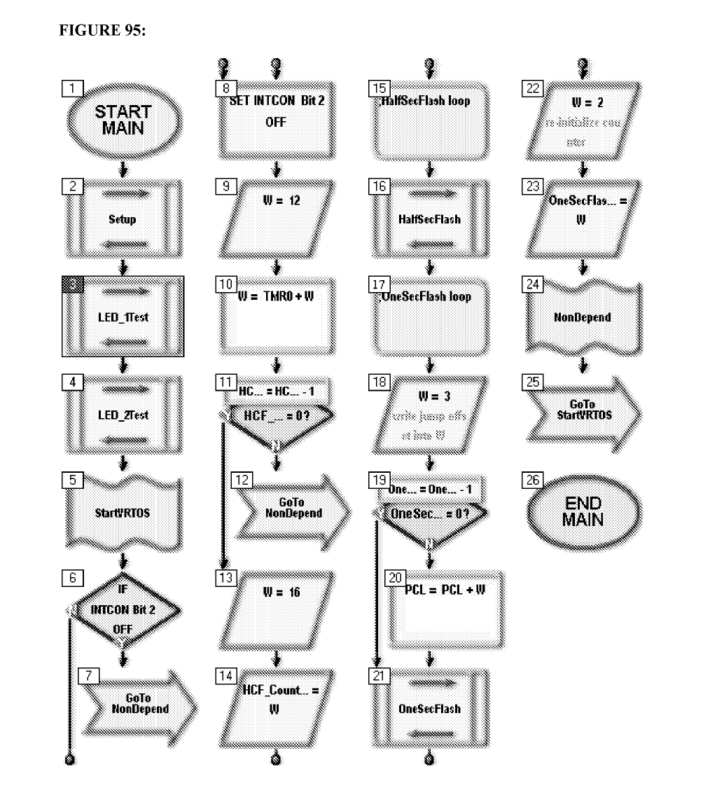

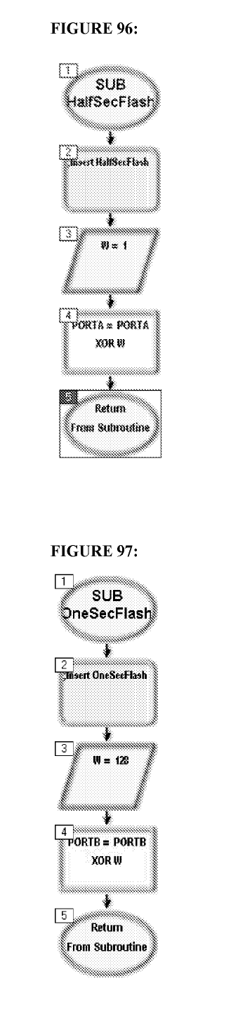

The user selects a sub-circuit and attaches it to a programmable controller pin. The user then selects another sub-circuit and attaches it to another pin of the controller. In this way the user attaches all the sub-circuits that are determined to be necessary by the user. An attachment diagram is thus created as in FIG. 1.

It is apparent that a complete circuit diagram picture can thus be generated as in Table 2 since each sub-circuit contains its own circuit picture.

TABLE 2
Automatic Generation of Circuit Schematic
Complete Circuit Diagram picture consists of:

| | |
|---|---|
| a) | Controller Circuit picture |
| b) | Power Regulator1 picture |
| c) | Switch Diagram1 picture |
| d) | LED Diagram1 picture |
| e) | Motor Diagram1 picture |
| f) | RS232 Driver1 picture |

A complete parts list can similarly be generated as in Table 3. These are useful engineering details for the hardware assembly of the complete circuit.

TABLE 3
Automatic Generation of Parts List
Complete Circuit Parts List consists of:

| | |
|---|---|
| a) | Specified Controller |
| b) | 7805 Regulator, 2x 100n Capacitors |
| c) | Switch, 10k resistor |
| d) | LED, 390R resistor |
| e) | DC Motor, L293 Driver |
| f) | MAX232 Chip, 5 x 100n Capacitors |

The mechanism of the current invention also allows for automatic generation of a hardware test procedure as shown in Table 4. Since known input states must exist on each sub-circuit connection pin, therefore it can be tested on the pin socket of the programmable controller to determine if the sub-circuit is operating correctly. Similarly known output states will activate sub-circuits with documented outcomes. Hence a signal can be injected onto the pin socket and the sub-circuit outcome compared to the sub-circuit description to check if it has passed the test.

TABLE 4
Automatic Generation of Hardware Test Procedure
FIG. 1 Complete Circuit Test procedure is as follows:
All testing to occur on top of Programmable Controller socket

| | |
|---|---|
| a) | Check pins 1 and 8 have: Input Power as specified in Sub-Circuit 1 |

Outputs tested first

| | |
|---|---|
| b) | Connect +Power pin to Digital Output pin 7. Check that Sub-Circuit 3 |
| | activates |
| c) | Connect +Power pin to Digital Output pin 6. Check that Sub-Circuit 5 |
| | activates |
| d) | Connect +Power pin to pin 3 and −Power pin to pin 4. Check that |
| | Sub-Circuit 4 activates in the correct direction. |
| e) | Connect +Power pin to pin 4 and −Power pin to pin 3. Check that |
| | Sub-Circuit 4 activates in the opposite direction. |

Inputs tested next

| | |
|---|---|
| f) | Connect Digital Output pin 7 to Digital Input pin 2. Check that Sub- |
| | Circuit 3 activates |
| g) | Connect Digital Output pin 7 to Digital Input pin 5. Check that Sub- |
| | Circuit 3 activates |

The mechanism of the current invention also allows for programmable controller settings to be assigned to the controller software for the setting of controller pins as in Table 5 and the setting of peripherals as in Table 6.

TABLE 5
Automatic Software Assignment of Controller PIN Settings

Pin 2: Digital Input
Pin 3: Digital Output
Pin 4: Digital Output
Pin 5: Digital Input
Pin 6: Digital Output
Pin 7: Digital Output

TABLE 6
Automatic Software Configuration of Controller Peripherals

Pin 6: RS232 Serial Output
Pin 5: RS232 Serial Input

Further, the mechanism of the current invention also allows some programmable controller software variables to be automatically generated. Table 7 shows bit variable names used in the software to access the functions on the pins of the programmable controller.

TABLE 7
Automatic Software Set up of Bit Variables for Pin access

Pin 2: Switch1
Pin 3: Motor_Forward
Pin 4: Motor_Backward
Pin 5: RS232_In
Pin 6: RS232_Out
Pin 7: LED

Finally, the mechanism of the current invention allows some programmable controller software structure to be generated automatically. Table 8 shows that necessary set up software can be inserted directly after the controller starts. Necessary software subroutines can also be automatically inserted for processing the input signals from the pins as well as for processing output signals to the pins.

TABLE 8
Automatic Software Set up of Operating System Requirements

START

Turn off LED
Turn off Motor
Set up RS232

Main_loop

Check Switch1 and de-bounce
Check for RS232 input

( Insert user software process here: Process inputs and set needed outputs )

Output RS232 as needed
Set Motor Outputs as needed
Turn On or Off LED as needed

Go to Main_loop

A specific implementation of the present invention will now be described in the form of a programming tool designed to program a microcontroller using the graphic symbol feature of the present invention. The specific implementation of software is called “ezCircuit Designer”.

### Basic Actions

### Basic Actions Include:

Adding a Circuit to a Micro-controller
Viewing Circuit Diagram
Viewing Circuit Information
Moving a Circuit Connection
Editing a Pin Name

### Add a Circuit to a Micro-Controller

1. To start adding a circuit, select a circuit group button.

See FIG. 2 of the attached Drawings.

2. Next, select a circuit from the list.

See FIG. 3 of the attached Drawings.

3. After a circuit has been selected, the circuit's connections are displayed in a list and some of the pins on the chip will change their colour. The highlighted connection in the list is the next one to be added to the circuit.

All of the green pins are compatible with the selected connection. Different pins on the micro-controller support different modes. Compatible pins are those pins that satisfy the modes required by the current circuit connection. Please see the micro-controller's datasheet for more information on what modes are supported by each pin.

The highlighted green pins are the ‘suggested’ pins. These pins support all the modes required by the selected connection, but also have the least number of other modes that will not be used by that connection. Using the ‘suggested’ pins leaves the pins with more modes available for other connections.

An error message is displayed if there are not enough compatible pins available for a selected circuit.

See FIG. 4 of the attached drawings.

3. Select an available pin for each connection required by the circuit. As pins are selected, their colour changes from green back to blue and the connection is added to the diagram, having been removed from the list.

See FIG. 5 of the attached drawings.

4. On completion of pin selection, the circuit is added to the micro-controller and the default pin names are assigned.

See FIG. 6 of the attached drawings
Remove a Circuit from the Micro-controller

1. Click on the unwanted circuit in the main window. After selection, the colour of the circuit block will change to orange.

See FIG. 7 of the attached drawings

2. Click on the Edit menu and then click Delete to remove the unwanted circuit.

See FIG. 8 of the attached drawings
Shortcut: You can also press the Delete key on the keyboard to remove the selected circuit from the micro-controller.

### To View Circuit Diagram

1. Click on a circuit block in the main window of ezCircuit Designer. When the circuit block is selected, its colour will change to orange.

See FIG. 9 of the attached drawings

2. Double click on the selected circuit block to view the diagram for that circuit.

See FIG. 10 of the attached drawings

3. To return to the main window, click on the Main button. Alternatively select Main from the Go To bar.

### To View Circuit Information

1. After selecting to view a circuit diagram, you will be at the circuit window for the selected circuit.

2. Click on the information icon to view the circuit information.

See FIG. 11 of the attached drawings

3. The information document will open after the information icon has been clicked.

See FIG. 12 of the attached drawings

### Move A Circuit Connection

1. Click and hold the left mouse button over the connection block to be moved.

See FIG. 13 of the attached drawings

2. While still holding the left mouse button down, drag the mouse cursor to the pin that the connection is to be moved to. When starting to drag, the pins compatible to the selected connection will change colour to green.

See FIG. 14 of the attached drawings

The mouse cursor will change to indicate if it is or is not over a compatible pin.

See FIG. 15 of the attached drawings

3. When the mouse is over the desired compatible pin, release the left mouse button and the connection will be moved.

See FIG. 16 of the attached drawings

### Edit Pin Name

1. In the main window, bring up a context menu by right-clicking on the pin name to be edited and select Rename.

See FIG. 17 of the attached drawings

Alternatively, if in the circuit window, simply left-click on the pin name to be edited.

Note that the pin names for some circuits cannot be edited. Power Supply, Oscillator and Reset Button circuits are not attached to pins that can be accessed in the assembly code and therefore have no pin names.

2. A text box will be displayed, allowing the name to be edited.

See FIG. 18 of the attached drawings

Note that because pin names are used in the generated assembly code, not all characters are accepted. Acceptable assembly code names start with a letter and only contain letters, digits and underscores.

3. Press the Enter key or click outside of the text box to finish editing the pin name. If an acceptable assembly code name has been given, the text box will be removed and the pin's name will be set.

See FIG. 19 of the attached drawings
Note: Descriptive pin names can help identify what circuit connection is connected to what chip pin. The main purpose of pin names though, is to be used in the generated assembly code, as names that identify the addresses of pins. This means that the pin can be accessed in the assembly program with the pin name rather than the numerical address.

### Advanced Functions

The following is a list of advanced functions supported by ezCircuit Designer.

### Chip Selection

### Generate Assembly Code

### Add/Edit Circuit Group Wizard

### Add/Edit Circuit Wizard

### Chip Selection (Change the Micro-controller)

1. In the Options menu of ezCircuit Designer click on Chip Selection.

See FIG. 20 of the attached drawings

2. Select a micro-controller model from the pop up Chip Selection dialog box and then click OK.

See FIG. 21 of the attached drawings

Note that the Suggestion button highlights the model of the smallest micro-controller that can have all of the circuits in the current project attached to it.

3. The micro-controller is changed and the program tries to move the circuits from the previous micro-controller to the new one.

See FIG. 22 of the attached drawings
Shortcut: You can also double-click on the chip diagram or click on the chip icon from the program to change the micro-controller.

### Generate an Assembly Test Program File

1. Click on the Options menu, then click Generate ASM File.

See FIG. 23 of the attached drawings

2. A message box pops up informing the user that the Assembly file has been saved to the project folder.

See FIG. 24 of the attached drawings

### Add/Edit Circuit Group Wizard

This help page explains how to add a new Circuit Group or edit an existing one.

1. To start, click on the Add button.

See FIG. 25 of the attached drawings

2. The Start Panel for the Wizard will be displayed. Click one of the buttons to select whether to ‘Add New Circuit Group’, ‘Add a New Circuit Group Based on an Existing Circuit Group’ or ‘Edit an Existing Circuit Group’.

See FIG. 26 of the attached drawings

If ‘Add New Circuit Group’ is selected, go to step 4.

3. If ‘Add a New Circuit Group Based on an Existing Circuit Group’ or ‘Edit an Existing Circuit Group’ was selected, the panel to select an existing Circuit Group will be displayed. Note that it is not possible to edit a circuit group that came installed with ezCircuit Designer, but you can base new circuit groups on them. Select a circuit group and click the Next Button.

See FIG. 27 of the attached drawings

If editing a circuit group, go to step 5.

4. If adding a new circuit group, the Circuit Group Name panel will be displayed. A generated unique name will initially be shown in the text box. Enter an appropriate name and click Next. If the name given is not unique, an error message will be given.

See FIG. 28 of the attached drawings

5. The icon panel will be displayed next. The icon currently set to represent this circuit group is shown in the centre of the panel. This is the icon that will be displayed in the main ezCircuit Designer window along with the icons for all other circuit groups. Clicking the Browse button will bring up an Open File Dialog Box, allowing a different image file to be selected and used as the icon. When an appropriate icon has been set, click the Next button.

See FIG. 29 of the attached drawings

6. The tool tip panel is displayed last. The tool tip is the text that appears when a user's mouse cursor hovers of the circuit group's icon in the main ezCircuit Designer window. Enter an appropriate tool tip and click the Finish button to end the Add Circuit Group Wizard.

See FIG. 30 of the attached drawings

When the Finish button is clicked, the circuit group will be saved and added to ezCircuit Designer.

### Add/Edit Circuit Wizard

This help page explains how to add a new Circuit or edit an existing one.

1. To start, click on the Add button.

See FIG. 31 of the attached drawings

2. The Start Panel for the Wizard will be displayed. Click one of the buttons to select whether to ‘Add New Circuit’, ‘Add a New Circuit Based on an Existing Circuit’ or ‘Edit an Existing Circuit’.

See FIG. 32 of the attached drawings

If ‘Add New Circuit’ is selected, go to step 4.

3. If ‘Add New Circuit Based on an Existing Circuit’ or ‘Edit an Existing Circuit’ was selected, the panel to select an existing Circuit will be displayed. Select a circuit and click the Next Button.

See FIG. 33 of the attached drawings

If editing a circuit, go to step 6.

4. If adding a new circuit, the ‘Select a Circuit Group’ panel is displayed. Select the group that this circuit will belong to and click the Next button.

See FIG. 34 of the attached drawings

5. If adding a new circuit, the ‘Circuit Name’ panel is displayed. A generated unique name will initially be shown in the text box. Enter an appropriate name and click Next. If the name given is not unique, an error message will be given.

See FIG. 35 of the attached drawings

6. The ‘Circuit Description’ Panel is displayed. The description is displayed in the ezCircuit Designer circuit window when the circuit diagram is being viewed. Give a description of the circuit and click the Next button.

See FIG. 36 of the attached drawings

7. The ‘Further Information Document’ panel is displayed. The further information document is displayed when the information button is clicked in the ezCircuit Designer circuit window. Click the Browse button to bring up a Open File Dialog Box to locate a document.

See FIG. 37 of the attached drawings

8. The ‘Electronic Components’ panel is displayed. To add a new component, enter the value and type of the component and the number of them required, then click the Add button. The drop down lists give suggested value units and types, but any text can be entered into them. To remove a component, select it in the list of All Components and click the Remove Selected button.

See FIG. 38 of the attached drawings

9. The ‘Circuit Test Procedure’ Panel is displayed. If desired, enter a description of how to test if the circuit is working correctly.

See FIG. 39 of the attached drawings

10. The ‘Circuit Special Cases’ panel is displayed. If any special cases are appropriate for this circuit, select them from the list.

See FIG. 40 of the attached drawings

11. The ‘Circuit Diagram File’ panel is displayed. Click the Browse button to bring up an Open File Dialog Box to locate a circuit diagram picture file for this circuit. Click the Set Up Connections button to bring up the separate ‘Circuit Diagram Form’. Note that a circuit requires at least one connection before it can be used in ezCircuit Designer.

See FIG. 41 of the attached drawings

12. If the Set Up Connections button in the ‘Circuit Diagram File’ panel is clicked, then the ‘Circuit Diagram Form’ is displayed. This form allows connections to be added and removed from the circuit and the Pin Names to be positioned on the circuit diagram.

See FIG. 42 of the attached drawings

Clicking the Add button brings up the ‘Add New Connection’ form to allow connection properties to be set up. Clicking the Remove button removes the selected connection. Double clicking on a connection will bring up the ‘Edit Connection’ form. The pin name for a connection can be moved about the circuit diagram by clicking and dragging it into position.

The ‘Add New Connection’ or ‘Edit Connection’ form allows the modes and default pin name of a connection to be set. Note that each circuit connection requires at least one mode before it can be used in ezCircuit Designer.

See FIG. 43 of the attached drawings

13. When the Next button is clicked in the ‘Circuit Diagram File’ panel, the ‘Computer Aided Design Files’ panel is displayed. If there is a Proteus Schematic Section file for the circuit, clicking the Browse button will bring up an Open File Dialog Box to located it. This file is used when a project using the circuit is exported to Proteus.

See FIG. 44 of the attached drawings

The ‘Computer Aided Design Files’ panel is the last panel in the Add Circuit Wizard. Click the Finish button and the circuit will be saved and added to ezCircuit Designer.

### View Part List

1. Click on Options menu in ezCircuit Designer, then click View Part List.

See FIG. 45 of the attached drawings

2. The Part List dialog box will pop up.

See FIG. 46 of the attached drawings

3. Click Export to Excel to save the part list to an Excel spread sheet, otherwise click Close.

4. If Export to Excel is clicked, then the Part List file is saved to the project folder and the file is opened in Excel, if Excel is installed.

Shortcut: You can also click on the part list icon to export the part list.

### View Test Procedures

1. Click on the Options menu of the program, then click View Test Procedures.

See FIG. 47 of the attached drawings

2. A Test Procedure dialogue box will pop up.

See FIG. 48 of the attached drawings

Shortcut: You can also click on the test procedure icon to view the test procedure.

### View Pin Settings

1. Click on Options menu of ezCircuit Designer, then click View Pin Settings.

See FIG. 49 of the attached drawings

2. A Pin Settings dialogue box will pop up.

See FIG. 50 of the attached drawings

3. When finished viewing, click Close to close the dialogue box.

Note: When you save the project the contents of Pin Settings will be saved as a text file in the Project Folder.

### Export to Proteus

1. Select the Export to Proteus menu item from the Options menu.

See FIG. 51 of the attached drawings

2. A message box will be displayed explaining that, after clicking OK, you will need to wait until Proteus has finished loading before using the mouse or keyboard again. Using the mouse or keyboard may disrupt the export process and cause problems.

See FIG. 52 of the attached drawings

3. After clicking OK, Proteus will launch and the export process will load the schematic for the project's micro-controller . . .

See FIG. 53 of the attached drawings
. . . and open Proteus' Import Section dialog box for you to import the other circuits in the project.
   See FIG. 54 of the attached drawings

### Send a Test Program to CoreChart

1. Click on the Options menu, then click Send to CoreChart.

See FIG. 55 of the attached drawings

2. If CoreChart is installed, the generated ASM file will be exported to CoreChart.

See FIG. 56 of the attached drawings

3. Once CoreChart is loaded, the screen above will be displayed. Click on import and the program will be ready to download to the micro-controller.

### Application Project Example

The following is one project example. This example is a two player Reaction Game.

Step 1: Start a New ezCircuit Designer Project

Start ezCircuit Designer and choose “Create New Project”.

If a project is already open then choose “New” from the File menu.

A “Create a New Project” window will appear. In the “Name” box type “Reaction Game” as the name of the new project folder.

Select a location for the new project folder on the computer.

Press “OK”

Document the Project

Before starting any project it is important to clearly define the project. This helps to clarify what the project will do. It communicates all aspects of the project to other people.

To create a document, select “Create Document” under the “Documentation” menu. Next select “Specification”.

See FIG. 57 of the attached drawings

Click on “Introduction” to highlight it and then click the “Edit Contents” button.

See FIG. 58 of the attached drawings

See FIG. 59 of the attached drawings

Write a brief summary of this project (as above) and click “Save”.

We will also fill in the details for the rest of the documents as follows:
(1) Functional Requirement:

A central LED on this game will turn on after a random time. Two
players will press their own push button as soon as they see a
central LED turn on. A LED next to the fastest player will flash. A
buzzer will generate sounds for the game.

(2) Non functional Requirement

Build a Reaction Game using an eLab16m controller board. Make it
fun and exciting for the user

(3) Requirement Specification Rationale

The reason is to design a fun electronic game that is an easy
example of using ezCircuit Designer, the elab16m controller and
CoreChart programming.

(4) Appendix

1. Websites
http://www.elabtronics.com
http://www.microchip.com
2. Reference Books
3. Other Resource

### Step 2: Chip Selection

Since this is a New Project the PIC12F629 chip is always the default chip.

For this project we will use the PIC16F819 chip.

Double click on the central chip and select “PIC16F819” from the list. Click OK.

See FIG. 60 of the attached drawings

### Step 3: Add LEDs

Choose the LED icon in the “Groups of Circuits”.

See FIG. 61 of the attached drawings

Select “active HIGH” in the “Circuits” menu and click on pin 13 of the chip. Add the same LED circuit to pins 17 and 18 on the chip.

See FIG. 62 of the attached drawings

Rename each of the LED circuits. Right click on the LED label and choose Rename. Change the LED names as follows:
LED13 to CentralLEDYel
LED17 to Player1Green
LED18 to Player2Red
   See FIG. 63 of the attached drawings

### Step 4: Add Buttons

From the “Groups of Circuits” menu click the “Button” icon. Select the “Pull up” circuit in the “Circuits” menu.

See FIG. 64 of the attached drawings

Add the “Button” circuit to pin 4.

Select the “Button” icon again and this time select the “Pull Down” circuit in the “Circuits” menu. Add the second “Button” circuit to pin 6 as shown below.

See FIG. 65 of the attached drawings

Rename “Button4” to “Player1Button” and “PllDwnButton6” to “Player2Button”.

See FIG. 66 of the attached drawings

### Step 5: Add a Buzzer

Select the Buzzer icon in the “Circuit Groups” menu.

See FIG. 67 of the attached drawings

Add the “Piezo Buzzer” to pin 15 of the chip by clicking on pin 15.

See FIG. 68 of the attached drawings

Rename “Buzzer15” to “Speaker”.

See FIG. 69 of the attached drawings

### Step 6: Change the Power Supply

The eLab16m board already has a power supply pre-built into the circuit. In fact, the type of the power supply is the “One_Diode_PS”. In ezCircuit, the default power supply is always the 5V Voltage Regulator. Therefore, change the power supply to the “One_Diode_PS”.

Delete the “power supply circuit” by selecting one of its connections and pressing the “Delete” key on the keyboard.

See FIG. 70 of the attached drawings

Click Ok when you see this message.

See FIG. 71 of the attached drawings

The Power Supply Circuit is next removed from the design.

Click on the Power Supply icon and select the “One_Diode_PS”.

See FIG. 72 of the attached drawings

Click on pin 14 and pin 5 to connect the power supply to the chip.

See FIG. 73 of the attached drawings

Rename the pins to “PowerSupply1” and “PowerSupply”

See FIG. 74 of the attached drawings

### Step 7: Adding in Programmer Circuit

Select the Programmer Circuit icon under the Circuit Group menu and click on “Add”

See FIG. 75 of the attached drawings

The Programmer Circuit is inserted in the project. The Programmer Circuit is found connected to Pin 4, 5 and Pin 12, 13 and 14.

See FIG. 76 of the attached drawings

Click on the Programmer Circuit to bring the circuit forward.

See FIG. 77 of the attached drawings

### Step 8: Printing the Documents and Circuitry

Before we continue make sure the project is saved by clicking on “Save” under the “File” menu.

It is easier to build the circuit if the circuit diagrams are pinted out. To do this click on “Print” under the “File” menu.

See FIG. 78 of the attached drawings

“Print Project Documents” sub-menu will appear. Select the documents to print by clicking on the tick box next to the selected item. In this case select all the documents to print.

See FIG. 79 of the attached drawings

### Step 9: Part List

The “Part List” shows all the parts required to build the Reaction Game circuit from scratch. Nore that most of the parts for the circuit are available on the elab16m controller board.

Part List
--------------------
Microcontroller
--------------------
1 × PIC16F819
1 × 18 pin IC Socket
1C Pin Connector
--------------------
1 × 10 Pin Connector
Capacitor
--------------------
1 × 100 μF Capacitor
Diode
--------------------
1 × Diode
Piezo Buzzer
--------------------
1 × Piezo Buzzer
power supply
--------------------
1 × 4.5 V power supply
Push Button
--------------------
1 × Push Button
1 × Push Button
LED
--------------------
2 × Green LED
1 × Yellow LED
Resistor
--------------------
3 × 390 Resistor
1 × 10 k Resistor
5 × 390 Resistor
3 × 10 k Resistor
1 × 33 k Resistor
Switch
--------------------
1 × Switch

### Step 10: Export to CoreChart

After the hardware circuit is built it can be tested by running the test software on the chip. ezCircuit Designer generates the test software from the circuits designed.

Note: At this point, please ensure that CoreChart version 2.4.25 or higher is installed on your PC.

Click on “Send to CoreChart” under “Options” in the main menu.

See FIG. 80 of the attached drawings

CoreChart starts up automatically and the window below will appear. Click “Import”.

See FIG. 81 of the attached drawings

After importing the file i.e. ezCircuit sends an ASM file to CoreChart, the test program will be displayed.

See FIG. 82 of the attached drawings

The pin names have been translated to Bit Variables in CoreChart. This saves time in matching the Port pins to the circuit. To view the User Variable List click “Variables . . . ” under “Edit” in the main menu bar.

See FIG. 83 and FIG. 84 of the attached drawings
Step 12: Download the Program into Chip

Once you have imported the Test Program from ezCircuit, save the file using a new name “TestProgram”.

Plug the USB programmer into the “CON1” connector of the elab16m module. Plug the battery pack into the eLab16m and turn on the power switch.

On the CoreChart main menu bar select “Tools” and click on “Send to Chip”.

See FIG. 85 of the attached drawings

Once the program has been successfully downloaded into the chip, a GREEN status bar on the USB programmer software will appear. If the status bar is RED check that all the cables are connected correctly and the power on the eLab16m is turned on.

See FIG. 86 of the attached drawings

### Step 13: Run Test Program

After verifying that the USB programmer system is running properly, the circuits can be tested by activating the outputs on the chip. The test program will do this.

See FIG. 87 of the attached drawings

There are 6 things that the microcontroller will do on this software:
1. Icons 3 to 6: Set the frequency of the chip to 8 Mhz.
2. Icon 8: Turn all Ports on the chip to Digital.
3. Icons 9 and 10: A delay is inserted before starting the main program.
4. Icon 11: Turn on “Player1Green” LED and then Turn it off.
5. Icon 12: Turn on “Player2Red” LED and Turn it off.
6. Icon 13: Turn on “CentralLedYel” LED and then Turn it off.
7. Icon 14: Turn on Speaker Buzzer and then Turn it off.

Run the Test Program by pressing the “Player1Button” once. The “Player1Button” is the push button on the elab16m. The program will run the sequence as shown above.

Check that all three LEDs and the Buzzer turn on and off once. If one of them does not respond, check that the wires are connected correctly and tightly.

It is noted that although the implementation example and project example shown here generate software in assembler or CoreChart graphical assembler, this invention is also applicable to any other software languages such as: C, Basic, Java, Ladder Logic, Assembler for other microcontroller families, etc.

The following is an example of how tasks may be graphically added using forms:

### User Control Display

Task ( 1 )
Name: ( 2 )
Description: ( 3 )
Input: ( 4 )
Output: ( 5 )
Timing: ( 6 )
Type: ( 7 )
( 1 ) - Task ID set automatically. Numbering starts from 1.
( 2 ), ( 3 ) - Task name and description entered by user.
( 4 ), ( 5 ) - Displays the input and output selected by user. Inputs and outputs are either hardware selected in the ezCircuit project view, or Memory Registers created in the Add/Edit Variables form. None can also be selected for ( 4 ) only, for tasks that perform actions unconditionally.
( 6 ) - Displays the timing type and the respective lower and/or upper timing bounds. *
( 7 ) - Displays task type and number of loops.
Note:
* Not Critical: No timing displayed.
Fixed: Displays lower. (Upper bound is ignored)
Bounded: Displays lower and upper bounds.

When an individual task is selected for editing, via double clicking on it or clicking on Edit Task, or when a new task is created, the Add/Edit task form is displayed.

See FIG. 88 of the attached drawings

(1)—The task's name, to be displayed in the main form, and used as the subroutine name in assembly and CoreChart. Required field. Names must only contain letters and spaces.

(2)—A short description to explain the task's function. Optional.

(3)—The input selection drop box displays all available hardware inputs as well as task variables created by the user. Currently only one input can be selected for each task. If memory register is selected, the list of task variables (4) is made available. None can also be selected for inputs, which is used for tasks that occur unconditionally, and are not dependant on any other tasks.

(5)—The output select drop box, similar to (3), but None cannot be selected—all tasks must have a function.

(6)—Allows selection of timing type and periods.

Type—allows for the selection between three timing types—Fixed, bounded, and Not Critical.

Fixed is for time critical tasks that must be run at a certain time, and the time algorithms will give these tasks priority.

Bounded timing is for tasks that are to be executed within a specific time range. When selected, Lower specifies the lower bound for a bounded type task, and Upper the upper bound.

Not Critical is for tasks not dependant on timing, but rather on other tasks completing first.

(7)—Allows for selection of task operation type, for which the options are iterative, conditional, immediate, and parallel data stream, as well as the number of loops of the task.
(8)—Task variable form button. Opens up the task variable form.

### Task Variable Form

The Task Variable form is accessed when the Task variables button in the Add/Edit task form is selected. It allows task variables to be defined before their use in a task.

See FIG. 89 of the attached drawings

(1)—Allows entry of the name of the variable to be added or changed. Once variable is added via (3) it will appear in the list below—(2).

(2)—Displays the list of existing variables. Clicking a variable in the list selects it to allow for renaming or deleting. This list will be shown in the Add/Edit task form when a Memory Register input or output is used.

(3)—Allows the new variable named in (1) to be added to the variables list. Note: Variable name can only consists of letters; numbers and symbols are not accepted.

(4)—Allows the renaming of an existing task variable. Renames selected variable from variable list (2) with the new variable name assigned in (1). If the variable was already in use by tasks when renamed, the name change will be automatically updated in those tasks.

Note: New variable name assigned must not already exist in the variable list.

(5)—Allows the selected task variable to be deleted from the list. If the variable is still in use by tasks when deleting, you can choose whether to replace the variable used for input/output with the default value, or have every task using the deleted variable removed. The renaming choice could be useful if the created tasks are still relevant but the need for a variable between them is no longer necessary.

(6)—Closes the form and returns to Add/Edit task form.

The following is an example project to illustrate the use of this invention. This project will flash a LED at a specified rate.

Step 1: Select eLab16m Template

The electronic control hardware is built using the eLab16m board.
a. Start up ezCircuit Designer.
b. Enter the “File” drop menu and click “Open”.
c. Enter the “ezCircuit” folder then click on “Examples” folder.
d. Select “eLab16m.ezproj” which should look like FIG. 1.1.
   See FIG. 90 of the attached drawings

### Step 2: Create Project Documents

a. In the main menu bar click on “Documentation”, “Create Document” and “Specification”.
b. Fill in “Introduction”, “Functional Requirement” and “Requirement Specification Rationale” with the following suggested information:
   Introduction: The aim of this project is to build an LED flasher.
   Functional Requirement: The on-board yellow LED will flash every second and an external LED connected to A0 will flash ever 0.5 second.
   Requirement Specification Rationale: Learn to create timed tasks using VRTOS.

### Step 3: Add LED Circuit to Design

a. Select the “LED” icon in “Circuit Groups” menu.
b. Next select “Active High” in “Circuit Types” drop down menu and click on pin 17.
c. Rename “LED17” to “RedLED”.
   See FIG. 91 of the attached drawings
d. Delete the Motor Drivers by clicking on one of the “Driver” Circuit boxes to highlight it.
e. Press “Delete” on the keyboard.
f. Go to “File” drop down menu and click “Save as . . . ”.
g. Re-name the ezCircuit Designer project as “LED_Flasher”

### Step 4: Create VRTOS Tasks

a. Click on “Open VRTOS” under the “Options” menu or click the VRTOS icon as shown in FIG. 3.2. This will open the VRTOS window.
   See FIG. 92 of the attached drawings
b. Go to “Task” drop down menu and click “Add Task”.
c. The task creation window opens up as shown in FIG. 3.3
d. Enter “OneSecFlash” as Task Name.
e. Enter “Flash yellow LED every second” as the Task Description.
f. Choose “Timing Dependent” from the “Operation Type”.
g. Enter “1” in timing length box and choose “s” for seconds from the combo box.
h. Leave “Number of Times Run” at “1”.

The window below will appear. Click “Ok”:

See FIG. 93 of the attached drawings

To create the other LED flash task;
i. Go to “Task” drop down menu and click “Add Task”.
j. The task creation window opens up as shown in FIG. 3.3
k. Enter “HalfSecFlash” as Task Name.
l. Enter “Flash red LED every half second” as the Task Description.
m. Choose “Timing Dependent” from the “Operation Type”.
n. Enter “500” in timing length box and choose “ms” for milliseconds from the combo box.
o. Leave “Number of Times Run” at “1”.
p. Click “Ok”.

The VRTOS window will have two tasks and look like the FIG. 94 of the attached drawings.

(NOTE: This project only uses timing dependent tasks; that is tasks that will occur every specified time period. VRTOS also has options to specify task-dependent tasks; i.e. a task that will occur when another specified task is complete, or non-dependent tasks; i.e. a task that will occur as often as possible.)

Now that the tasks are created, the task scheduling code can be generated in CoreChart.

Go to “File”, “Export”, “Export to CoreChart”.

### Step 5: Hardware Connection

a. Connect the white lead of the LED to the eLab16m terminal labeled “A0”.
b. Connect the black lead of the LED to the “−” terminal.

### Step 6: Insert Task Routines

The necessary code for the timing of tasks has already been generated. All that is required is the code for each task.

The CoreChart program should look like FIG. 5.1.
a. Save the CoreChart program as “VRTOS_LED”.
   See FIG. 95 of the attached drawings
b. Delete the output test subroutines “LED_{—}1Test” and “LED_{—}2Test” by clicking on their icon and pressing, “Delete”.
c. Double-Click the “HalfSecFlash” subroutine to enter it.
d. Connect the USBP programmer to the eLab16m and turn on the power.
e. To toggle the red LED on/off, insert the following code:
   See FIG. 96 of the attached drawings
f. Go back to the Main program by double-clicking “Return From Subroutine” and enter the “OneSecFlash” subroutine.
g. To toggle the yellow LED on/off, insert the following code:
   See FIG. 97 of the attached drawings
h. Plug in the USBP programmer cable to the computer.
i. Connect the programmer to the eLab16m and turn on the power.
j. Send the CoreChart test program to the chip.
k. Press and release the Reset Switch on the eLab16m to start the test program.

The on-board yellow LED will flash every second and the red LED will flash every half a second.

The claims defining the invention are as follows:

1. A method of developing a software structure for a programmable controller system, the method comprising attaching one or more sub-circuit symbols to a central controller symbol.

2. A method according to claim 1, wherein the sub-circuit is a graphical icon.

3. A method according to claim 1, wherein the central controller symbol is a block with attachment pins.

4. A method according to claim 1, wherein each sub-circuit contains predetermined parameters that can selectively be displayed to help the user make an informed and reasonable selection.

5. A method according to claim 1, wherein the central controller symbol may change during a sub-circuit selection to help guide the user, by matching the pins that can connect to the selected sub-circuit.

6. A method according to claim 1, wherein technical information is generated for the construction and testing of the programmable controller system.

7. A method according to claim 1, wherein the sub-circuit symbol contains a sub-circuit schematic that can be viewed by the user.

8. A method according to claim 1, wherein the software structure may include pin assignment software to configure the programmable controller to input or output the required signals.

9. A method according to claim 1, wherein the software structure may include software for setting required controller chip peripheral hardware that can process the signals connected to the pins.

10. A method according to claim 1, wherein the software structure may include assignment of variables and variable names for the signals and pins on the programmable controller.

11. A method according to claim 1, wherein the software structure may include information about operating system requirements.

12. A tool kit for generating technical data and software for electronic programmable controller systems as herein before described with reference to tables 1-8 and FIG. 1 of the accompanying drawings.

13. A method of developing a software structure for a programmable controller system, the method comprising entering task data into forms and an automated mechanism that incorporates the task instructions into a real time operating system that meets all the task requirements.

14. A method according to claim 13, Wherein the task is a graphical icon.

15. A method according to claim 13, wherein the real time operating system uses task instruction delays to meet timing requirements for all tasks.

16. A method according to claim 13, wherein each selection on a task form contains predetermined parameters that can selectively be displayed to help the user make an informed and reasonable selection.

17. A method according to claim 13, wherein the task instructions of all tasks within the real time operating system can be edited by the user.

18. A method according to claim 13, wherein the real time operating system may include assignment of variables and variable names for passing data between tasks.
